(19) United States
(12) Patent Application Publication
(10) Pub. No.: US 2026/0180053 A1
(43) Pub. Date: Jun. 25, 2026

(54) BATTERY PACK - POWER TOOL INTERFACE

(71) Applicant: Black & Decker Inc., New Britain, CT (US)

(72) Inventor: Tobias Demant, Idstein (DE)

(21) Appl. No.: 19/539,284

(22) Filed: Feb. 13, 2026

Related U.S. Application Data
(63) Continuation of application No. PCT/US2024/042976, filed on Aug. 19, 2024.
(60) Provisional application No. 60/520,316, filed on Nov. 17, 2003.
(60) Provisional application No. 63/520,315, filed on Aug. 17, 2023.
(60) Provisional application No. 63/584,755, filed on Sep. 22, 2023.
(60) Provisional application No. 63/520,317, filed on Oct. 24, 2023.
(60) Provisional application No. 63/622,460, filed on Jan. 18, 2024.

(51) Int. Cl. H01M 10/48; H01M 10/0525

(52) U.S. Cl. CPC H01M 10/48; H01M 10/0525

(57) ABSTRACT

An interface system for enabling mating and operation between a set of cordless power tools and a battery pack comprises a housing. The housing includes an interface for mating with the battery pack. The interface may include a set of rails, a set of grooves, a terminal block including a set of terminals, and a catch. The housing includes a first attachment feature configured to attach the housing to a first cordless power tool of the set of cordless power tools in a first orientation and a second attachment feature configured to attach the housing to a second cordless power tool of the set of cordless power tools in a second orientation.

### CROSS-REFERENCE TO RELATED APPLICATION(S)

This application is a continuation of Patent Cooperation Treaty Application No. PCT/US 2024/042976, filed on Aug. 19, 2024, entitled “Battery Pack—Power Tool Interface”, and claims the benefit of priority thereof under 35 U.S.C. § 120, and which claims the benefit of priority to each of: U.S. Provisional Patent Application Ser. No. 63/520,315, filed Aug. 17, 2023, titled “Battery Pack”; U.S. Provisional Patent Application Ser. No. 63/520,316 filed Aug. 17, 2023, titled “Battery Pack Charger”; U.S. Provisional Patent Application Ser. No. 63/520,317 filed Aug. 17, 2023, titled “Battery Pack Adaptor”; U.S. Provisional Patent Application Ser. No. 63/584,755 filed Sep. 22, 2023, titled “Battery Pack Interface”; and U.S. Provisional Patent Application Ser. No. 63/622,460, filed Jan. 18, 2024, titled “Battery Packs, Battery Pack Chargers, Battery Pack Interfaces and Adaptors of a Cordless Power Tool System”.

### INCORPORATION BY REFERENCE

Patent Cooperation Treaty Application No. PCT/US 2024/042976, filed on Aug. 19, 2024, entitled “Battery Pack—Power Tool Interface”, is incorporated herein in its entirety by reference.

U.S. Provisional Patent Application Ser. No. 63/520,315, filed Aug. 17, 2023, titled “Battery Pack”, is incorporated herein in its entirety by reference.

U.S. Provisional Patent Application Ser. No. 63/520,316, filed Aug. 17, 2023, titled “Battery Pack Charger”, is incorporated herein in its entirety by reference.

U.S. Provisional Patent Application Ser. No. 63/520,317, filed Aug. 17, 2023, titled “Battery Pack Adaptor”, is incorporated herein in its entirety by reference.

U.S. Provisional Patent Application Ser. No. 63/584,755 filed Sep. 22, 2023, titled “Battery Pack Interface”, is incorporated herein in its entirety by reference.

U.S. Provisional Patent Application Ser. No. 63/622,460, filed Jan. 18, 2024, titled “Battery Packs, Battery Pack Chargers, Battery Pack Interfaces and Adaptors of a Cordless Power Tool System”, is incorporated herein in its entirety by reference.

This application is related to U.S. patent application Ser. No. 18/114,121, filed on Feb. 24, 2023, titled “Cordless Power Tool System”, which in turn claims the benefit of priority from U.S. Provisional Patent Application Ser. No. 63/268,451, filed on Feb. 24, 2022, titled “Cordless Power Tool System”, the contents all of which are incorporated herein in their entireties by reference.

This application also is related to Patent Cooperation Treaty Application No. PCT/US2024/042983, filed on Aug. 19, 2024, titled “Battery Packs, Battery Pack Chargers, Battery Pack Interfaces and Adaptors of a Cordless Power Tool System”, which in turn claims the benefit of priority from U.S. Provisional Patent Application Ser. No. 63/622,460, filed Jan. 18, 2024, the contents all of which are incorporated herein in their entireties by reference.

This application also is related to Patent Cooperation Treaty Application No. PCT/US2024/042984, filed on Aug. 19, 2024, titled “Battery Pack”, which in turn claims the benefit of priority from U.S. Provisional Patent Application Ser. No. 63/622,460, filed Jan. 18, 2024, the contents all of which are incorporated herein in their entireties by reference.

This application also is related to Patent Cooperation Treaty Application No. PCT/US2024/042979, filed on Aug. 19, 2024, entitled “Battery Pack Charger”, which in turn claims the benefit of priority from U.S. Provisional Patent Application Ser. No. 63/622,460, filed Jan. 18, 2024, the contents all of which are incorporated herein in their entireties by reference.

This application also is related to Patent Cooperation Treaty Application No. PCT/US2024/042973, filed on Aug. 19, 2024, titled “Battery Pack Adaptor”, which in turn claims the benefit of priority from U.S. Provisional Patent Application Ser. No. 63/622,460, filed Jan. 18, 2024, the contents all of which are incorporated herein in their entireties by reference.

This application also is related to Patent Cooperation Treaty Application No. PCT/US2024/042820, filed on Aug. 16, 2024, titled “Cordless Power Tool System”, which in turn claims the benefit of priority from U.S. Provisional Patent Application Ser. No. 63/622,475, filed Jan. 18, 2024, the contents all of which are incorporated herein in their entireties by reference.

### FIELD

The patent application relates to a battery pack interface of a cordless power tool system.

### BACKGROUND

Removable, rechargeable battery packs are becoming ubiquitous as more and more devices become cordless to take advantage of the advances in battery technology. Such battery packs are commonly part of cordless power tool systems and are designed and configured to operate with a variety of cordless power tools.

Conventional rechargeable battery packs may include Li-Ion battery cells. Due to the nature of the chemistry of these battery packs, the United States and many other countries and international bodies, including the United Nations, have implemented special rules directed to the shipping of Li-Ion batteries. If a battery or battery pack exceeds these rules/limits, there are additional fees and shipping costs for shipping the battery pack. As such, there is an interest in keeping the Watt-hour levels below the 100 Wh limits. Today, it is common for Li-Ion batteries to exceed these limits. As battery power and capacity increases it will become more common for batteries to exceed these limits. As such, there is a great desire to keep address this issue.

Typically, shipping regulations impose limitations upon how much energy is disposed in a battery pack. For example, some regulations require that each cell have an energy equal to or less than 20 Watt-hours, and that each battery pack has an energy limit equal to or less than 100 Watt-hours. It is preferable to provide a solution that can maximize the energy available to the end user while complying with shipping regulations. Preferably, a switching system could be used to separate components of the battery pack, thus opening the battery pack circuit, limiting the energy output.

While, for ground service (highway and rail), United States Department of Transportation (USDOT) regulations allow for certain packaging and shipment exceptions for batteries below 300 watt-hours, USDOT regulations for batteries above 300 watt-hours require special packaging (e.g., “Class 9” packaging) around the battery packs for shipment to be permissible.

The present patent application describes an example battery pack for use with a power tool system utilizing pouch battery cells and an example method of manufacturing such a battery pack.

Typically, rechargeable battery packs are charged using battery pack chargers that are designed and configured to charge specific battery packs. These chargers are designed and configured to plug into a wall outlet for access to alternating current (AC) mains line (utility) power or some other source of AC power, such as a generator. The battery packs, the power tools, and the chargers generally include an interface system that enables the battery pack to couple to the power tool and the charger, as is well known in the art. Various interfaces are known for electrically and physically coupling the battery pack with an electrical apparatus such as a power tool or a battery pack charge.

While prior art power tool systems including a set of cordless power tools, a set of releasably attachable battery packs and a set of battery pack chargers all designed and configured to operate with each other by an original equipment manufacturer have proven to be more than suitable for their intended purposes, each battery pack in the set of battery packs is limited for use with an associated tool of the set of cordless power tools and an associated charger of the set of battery pack chargers. Thus, it remains desirable in the art to provide an adaptor for a first battery pack having a first configuration specifically designed and configured to operate with a first type of power tool system that enables use of the first battery pack as a substitute for a second battery pack having a second configuration specifically designed and configured to operate with a second type of power tool system. Further, the cordless power tools and the battery packs may be used in heavy contamination environments. This type of environment may expose the cordless power tools and the battery packs to water and particulate ingress that may reduce the performance and warranty life expectancy. The present patent application provides improvements in the battery pack adaptors.

### SUMMARY

One aspect of the present patent application provides an interface system for enabling mating and operation between a set of cordless power tools and a battery pack. The interface system comprises a housing. The housing includes an interface for mating with the battery pack. The interface may include a set of rails, a set of grooves, a terminal block including a set of terminals, and a catch. The housing includes a first attachment feature configured to attach the housing to a first cordless power tool of the set of cordless power tools in a first orientation and a second attachment feature configured to attach the housing to a second cordless power tool of the set of cordless power tools in a second orientation.

Implementations of the foregoing aspects may include one or more of the following features.

In an aspect of the present patent application, the housing may comprise a first housing portion, a second housing portion, and a core block positioned between the first and second housing portions. The core block may include the first attachment feature.

In an aspect of the present patent application, the first attachment feature may include a set of holes in the core block configured to mate with a corresponding fixture on the first cordless power tool.

In an aspect of the present patent application, the first and second housing portions may be attached to the core block such that the set of holes in the core block remain exposed to mate with the corresponding fixture on the first cordless power tool.

In an aspect of the present patent application, the second attachment feature may include a set of holes in the housing configured to mate with a corresponding fixture on the second cordless power tool.

In an aspect of the present patent application, the set of holes in the housing is a first set of holes. The housing may include a second set of holes that are configured to engage with a corresponding set of holes in the core block so as to connect the core block to the housing.

In an aspect of the present patent application, the first cordless power tool of the set of cordless power tools may include a concrete or a core drill.

In an aspect, in the first orientation, the interface may be positioned in a generally vertical orientation.

In an aspect of the present patent application, the second cordless power tool of the set of cordless power tools may include a rammer.

In an aspect of the present patent application, in the second orientation, the interface may be positioned in a generally horizontal orientation.

In an aspect of the present patent application, in the second orientation, the interface may be positioned in a generally angled orientation with respect to a vertical axis and a horizontal axis.

In an aspect of the present patent application, the battery pack may have a capacity of 10 Ah, an impedance of equal to or less than approximately 3 milliohms, and a nominal voltage of 54V.

In an aspect of the present patent application, the terminal block including the set of terminals may be coupled to or disposed on the core block.

In an aspect of the present patent application, the interface may include a wire harness that is configured to be electrically coupled to either the first cordless power tool or the second cordless power tool.

In an aspect of the present patent application, the interface may include a tool interface surface that is opposing a battery pack interface surface. The wire harness may be configured to extend from the tool interface surface.

In an aspect of the present patent application, the interface may include a front portion and a rear portion. The catch may be disposed in the front portion of the interface. The wire harness may be configured to extend from a rear surface of the rear portion of the interface.

Another aspect of the present patent application provides an interface system for enabling mating and operation between a set of cordless power tools and a battery pack. The interface system comprises a first housing and a second housing. The first housing includes an interface for mating with the battery pack. The interface includes a set of rails, a set of grooves, a terminal block including a set of terminals, and a catch. The first housing includes a first attachment feature configured to attach the interface to a first cordless power tool of the set of cordless power tools in a first orientation. The second housing is attached to the first housing. The second housing includes a second attachment feature configured to attach the interface to a second cordless power tool of the set of cordless power tools in a second orientation. The second housing may be positioned between the first housing and the second cordless power tool.

Implementations of the foregoing aspects may include one or more of the following features.

In an aspect of the present patent application, the first housing may comprise a first housing portion, a second housing portion, and a core block that is positioned between the first and second housing portions. The core block may include the first attachment feature.

In an aspect of the present patent application, the first attachment feature may include a set of holes in the core block configured to mate with a corresponding fixture on the first cordless power tool.

In an aspect of the present patent application, the second attachment feature may include a set of holes in the second housing configured to mate with a corresponding fixture on the second cordless power tool.

In an aspect of the present patent application, portions of the second housing that are positioned between the first housing and the second cordless power tool may be first housing portions of the second housing. The second housing may include second housing portions that are positioned on the sides of the first housing and the interface.

In an aspect of the present patent application, the first housing may comprise two housing portions forming an internal cavity and a core block is positioned in the internal cavity.

In an aspect of the present patent application, the terminal block including the set of terminals may be coupled to or disposed on the core block.

In an aspect of the present patent application, the interface may include a wire harness that is configured to be electrically coupled to either the first cordless power tool or the second cordless power tool.

In an aspect of the present patent application, the interface may include a tool interface side that is opposed to a battery pack interface side. The wire harness may be configured to extend from the tool interface side.

In an aspect of the present patent application, the interface may include a front portion and a rear portion. The catch may be disposed in the front portion of the interface. The wire harness may be configured to extend from a rear surface of the rear portion of the interface.

In an aspect of the present patent application, the first cordless power tool of the set of cordless power tools may include a concrete/core drill and drill stand combination.

In an aspect of the present patent application, in the first orientation, the interface may be positioned in a generally vertical orientation.

In an aspect of the present patent application, the second cordless power tool of the set of cordless power tools may include a concrete vibrator backpack.

In an aspect of the present patent application, in the second orientation, the interface may be positioned in a generally vertical orientation in use.

In an aspect of the present patent application, the second cordless power tool of the set of cordless power tools may include a concrete vibrator powerpack.

In an aspect of the present patent application, in the second orientation, the interface may be positioned in a generally horizontal orientation.

In an aspect of the present patent application, the second cordless power tool of the set of cordless power tools may include a concrete plate compactor, a screed or a rammer.

In an aspect of the present patent application, in the second orientation, the interface may be positioned in a generally angled orientation with respect to a vertical axis and a horizontal axis or in a generally horizontal orientation.

In an aspect of the present patent application, a direction of attachment of the interface to the first cordless power tool or the second cordless power tool is generally perpendicular to a direction of insertion of the battery pack on to the interface.

In an aspect of the present patent application, the battery pack may have a capacity of 10 Ah, an impedance of equal to or less than approximately 3 milliohms, and a nominal voltage of 54V.

These and other aspects of the present patent application, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the present patent application, the structural components illustrated herein are drawn to scale. It is to be expressly understood, however, that the drawings are for the purpose of illustration and description only and are not intended as a definition of the limits of the present patent application. It shall also be appreciated that the features of one embodiment disclosed herein can be used in other embodiments disclosed herein. As used in the specification and in the claims, the singular form of “a”, “an”, and “the” include plural referents unless the context clearly dictates otherwise.

Other aspects, features, and advantages of the present patent application will become apparent from the following detailed description, the accompanying drawings, and the appended claims.

Each of the aspects described above and in the following description can be used in any combination of one or more of these aspects, as will be understood to one of ordinary skill in the art.

### BRIEF DESCRIPTION OF THE DRAWINGS

FIGS. 1 and 2 show an example power tool system in accordance with an embodiment of the present patent application;

FIGS. 3A-3D show various views of a battery pack interface in accordance with an embodiment of the present patent application, wherein a view showing a tool engaging side of the interface is shown in FIG. 3A, a view showing a battery pack engaging side of the interface is shown in FIG. 3B, and side views of the interface are shown in FIGS. 3C-3D;

FIGS. 4A and 4B show various views of the interface of FIGS. 3A-3B with fasteners exploded out;

FIGS. 5A-5C show various exploded views of the interface of FIGS. 3A-3D;

FIG. 6 shows a detailed view of a terminal block of the interface of FIGS. 3A-3D;

FIG. 7 shows a detailed view of the terminal block of FIG. 6 and a portion of the interface, wherein FIG. 7 shows an upside down view of the portion of the interface;

FIGS. 8A-8D show various perspective views of an exemplary battery pack coupled to the interface of FIGS. 3A-3D, wherein the tool engaging side of the interface is shown in FIG. 8D;

FIG. 9 shows a cross sectional view of the battery pack and the interface of FIGS. 8A-8D;

FIGS. 10A-10F show various views of a first example power tool, FIGS. 10A and 10B show left and right side views, FIGS. 10C and 10E show front and rear views, and FIGS. 10D and 10F show perspective views, wherein the first example power tool is a core/concrete drill;

FIGS. 11A and 11B show detailed views of the power tool of FIGS. 10A-10F;

FIGS. 12A and 12B show a core block of the interface of FIGS. 3A-3D separated from and before being coupled to the power tool of FIGS. 10A-10F;

FIGS. 13A and 13B show various views of the core block mated to the power tool of FIGS. 10A-10F;

FIGS. 14A and 14B show various views of the core block fastened to the power tool of FIGS. 10A-10F;

FIGS. 15A and 15B show various views of a terminal block coupled to the core block;

FIGS. 16A and 16B show various views of a first interface housing portion mated to the core block;

FIGS. 17A and 17B show various views of the first interface housing portion fastened to the core block;

FIGS. 18A and 18B show various views of a second interface housing portion mated to the core block;

FIGS. 19A-19F show various views of the interface of FIGS. 3A-3D fastened to the power tool of FIGS. 10A-10F, FIGS. 19A and 19B show left and right side views, FIGS. 19C and 19E show front and rear views, and FIGS. 19D and 19F show perspective views;

FIGS. 20A and 20B show various detailed views of the interface of FIGS. 3A-3D fastened to the power tool of FIGS. 10A-10F;

FIGS. 21A-21F show various views of an example battery pack coupled to the interface and the power tool of FIGS. 19A-19F, FIGS. 21A and 21B show left and right side views, FIGS. 21C and 21E show front and rear views, and FIGS. 21D and 21F show perspective views;

FIG. 22 shows a detailed view of the battery pack, the interface and the power tool of FIG. 21A;

FIGS. 23A-23E show various views of a core block of an interface assembly in accordance with an embodiment of the present patent application;

FIGS. 24A-24E show various views of a terminal block coupled to the core block of FIGS. 23A-23E;

FIG. 25 shows a first interface housing portion mated to the core block of FIGS. 24A-24E;

FIGS. 26A-26C show various views of the first interface housing portion fastened to the core block of FIG. 25;

FIGS. 27A-27C show various views of a latch catch coupled to the first interface housing portion;

FIGS. 28A-28C show various views of a second interface housing portion coupled to the core block of FIGS. 24A-24E;

FIGS. 29A-29E show the second interface housing portion fastened to the core block of FIGS. 24A-24E;

FIGS. 30A and 30B show various views of a frame of a second example power tool, wherein the second example power tool is a rammer;

FIGS. 31A and 31B show detailed views of FIGS. 30A and 30B;

FIGS. 32A and 32B show various views of the interface of FIGS. 29A-29E fastened to the frame of the second example power tool of FIGS. 30A and 30B;

FIGS. 33A and 33B show detailed views of FIGS. 32A and 32B;

FIGS. 34A and 34B show various views of an example battery pack coupled to the interface and the power tool of FIGS. 32A and 32B;

FIGS. 35A and 35B show detailed views of FIGS. 34A and 34B;

FIG. 36 shows a first example wiring scheme of the interface of FIGS. 3A-3D;

FIG. 37 shows a second example wiring scheme of the interface of FIGS. 3A-3D;

FIG. 38 shows a third example wiring scheme of the interface of FIGS. 3A-3D;

FIG. 39 shows an example interface of the present patent application;

FIG. 40 shows a first example outer housing coupled to the example interface of FIG. 39;

FIG. 41 shows the combination outer housing and interface of FIG. 39 incorporated in a third example power tool;

FIG. 42 shows the combination outer housing and interface of FIG. 39 incorporated in a fourth example power tool;

FIG. 43 shows a second example outer housing coupled to the example interface of FIG. 39;

FIGS. 44A and 44B show a method of coupling an outer housing to the interface of FIG. 39;

FIG. 45 shows an example power tool system, including several example cordless power tools, battery packs, charger and battery pack adaptor, incorporating the battery pack interface of the present patent application, the cordless power tools may include screed/concrete screed, rammer, concrete vibrator power pack, concrete vibrator backpack, core drill stand, plate compactor, 12 inch cutoff saw, etc. ;

FIGS. 46A and 46B show a side view and a detailed view of an example power tool, wherein the example power tool is a rammer, wherein the battery pack is coupled to the interface;

FIG. 47 shows a perspective view of a power tool with an example interface coupled to the power tool, wherein the power tool is a core/concrete drill;

FIGS. 48-50 show exploded views showing portions of the power tool of FIG. 47, the interface, and portions of the façade/outer housing;

FIGS. 51-52 show various views of the interface of FIG. 47;

FIG. 53 shows a perspective view of an example power tool with the interface mounted therein, wherein the example power tool is a plate compactor;

FIGS. 54A and 54B show assembled views of the portions of the power tool of FIG. 53, the interface, and portions of the façade/outer housing;

FIGS. 55-56 show exploded views of the portions of the power tool of FIG. 53, the interface, and portions of the façade/outer housing;

FIG. 57 shows a perspective view of an example power tool with the interface mounted therein, wherein the example power tool is a rammer;

FIG. 58 shows an assembled view of the portions of the power tool of FIG. 57, the interface, and portions of the façade/outer housing;

FIGS. 59-60 show exploded views of the portions of the power tool of FIG. 57, the interface, and portions of the façade/outer housing;

FIG. 61 shows show a perspective view of the interface of FIG. 57;

FIG. 62 shows a perspective view of an example power tool with the interface mounted therein, wherein the example power tool is a screed;

FIG. 63 shows an assembled view of the portions of the power tool of FIG. 62, the interface, and portions of the façade/outer housing;

FIGS. 64-67 show exploded views of the portions of the power tool of FIG. 62, the interface, and portions of the façade/outer housing;

FIGS. 68-71 show various views of the interface of FIG. 62;

FIG. 72 shows a perspective view of an example power tool with the interface mounted therein, wherein the example power tool is a vibrator backpack,

FIG. 73 shows an assembled view of the portions of the power tool of FIG. 72, the interface, and portions of the façade/outer housing;

FIGS. 74A-75 show exploded views of the portions of the power tool of FIG. 72, the interface, and portions of the façade/outer housing;

FIGS. 76-77 show various views of the interface and removably attachable portions of the power tool of FIG. 72;

FIGS. 78-79 show various views of the interface of FIG. 72;

FIG. 80 shows a perspective view of an example power tool with the interface mounted therein, wherein the example power tool is a vibrator powerpack;

FIG. 81 shows show an assembled view of the portions of the power tool of FIG. 80, the interface, and portions of the façade/outer housing;

FIGS. 82A-85 show exploded views of the portions of the power tool of FIG. 80, the interface, and portions of the façade/outer housing;

FIG. 86 shows a perspective view of an example power tool with the interface mounted therein, wherein the example power tool is a vibrator backpack;

FIG. 87 shows a perspective view of an example power tool with the interface mounted therein, wherein the example power tool is a vibrator powerpack; and

FIG. 88 shows a perspective view of example power tools with the interface mounted therein, wherein the example power tools are a vibrator backpack and a vibrator powerpack.

### DETAILED DESCRIPTION

Additional details of embodiments of various battery packs and power tools considered within the scope of the present disclosure can be found in at least U.S. Provisional Patent Application Nos. 62/636,395, 62/853,694, 62/636,568, 63/359,940, 63/533,751, 63/533,754, 63/533,755, 63/533,758, 63/578,008; U.S. patent application Ser. No. 18/114,121; U.S. Pat. No. 9,406,915; European Patent Application Nos. EP22202110.7, EP22194105.7, EP23163288.6, and EP23192793.0; PCT Patent Application Nos. PCT/EP2022/074710, PCT/EP2023/072939,PCT/EP2023/072638, and PCT/EP2023/072679; and U.K. Patent Application Nos. GB2112789.9, GB2209009.6, and GB2218350.3. The disclosures of each of the above applications and patents are hereby incorporated by reference in their entirety.

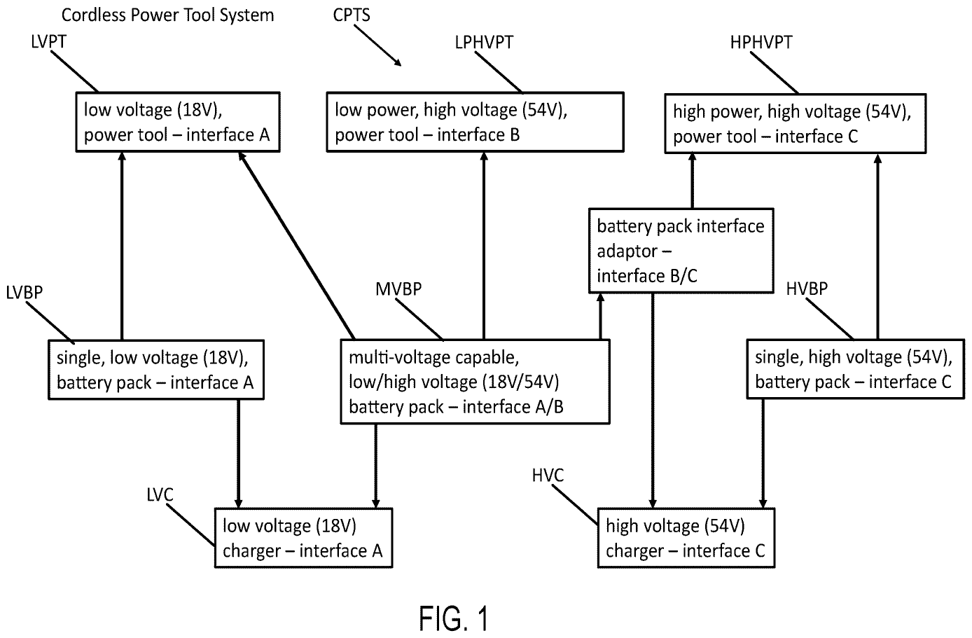

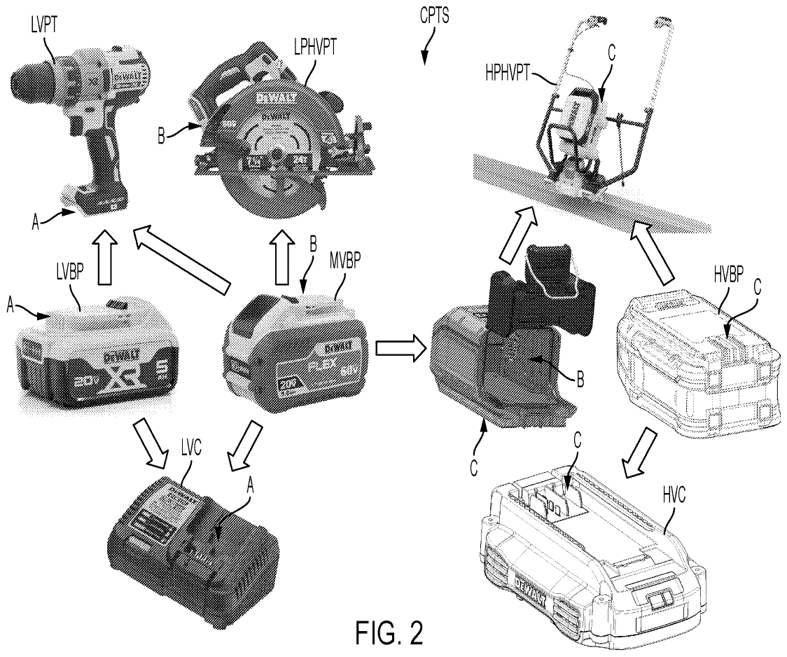

Referring to FIGS. 1-2, the present patent application provides a cordless power tool system (CPTS). The CPTS may include a first power tool, a second power tool, a third power tool, a first battery pack, and a second battery pack. The first power tool may include a high power, high voltage power tool (HPHVPT). The HPHVPT may have a first power tool rated voltage (e.g., 54 volts (V)). The HPHVPT may have a first power tool interface (e.g., interface C). The second power tool may include a low power, high voltage power tool (LPHVPT). The LPHVPT may have a second power tool rated voltage (e.g., 54V). The LPHVPT may have a second power tool interface (e.g., interface B) that is different from the first power tool interface (e.g., interface C). The third power tool may include a low voltage power tool (LVPT). The LVPT may have a third power tool rated voltage (e.g., 18V). The LVPT may have a third power tool interface (e.g., interface A) that is different from the first power tool interface (e.g., the interface C) and the second power tool interface (e.g., the interface B).

Referring to FIGS. 1-2, in one example embodiment, the CPTS may include a high voltage battery pack HVBP and a set of cordless HPHVPT (one shown). The CPTS also may include a high voltage charger HVC. Each of the cordless power tools of the set of cordless power tools may be powered by the HVBP. The set of power tools may include, for example, a screed, a concrete plate compactor, a rammer, a concrete vibrator powerpack, a concrete vibrator backpack, and a concrete/core drill. It is understood that the HPHVPT illustrated in FIGS. 1-2 are examples and that other power devices are contemplated to be included as part of the CPTS, even though not illustrated. In one example implementation, the HPHVPT have an operating voltage of 54V. Each HPHVPT may include a receptacle for receiving the HVBP. The power tool receptacle may include an interface for mating with the HVBP. The battery pack receptacle may be configured with one interface for receiving one removable, rechargeable battery pack, for example, from the HVBP.

The first battery pack may be a single (fixed), high voltage battery pack (HVBP). The HVBP may have a first nominal voltage (e.g., 54V) that is substantially the same as the first power tool rated voltage (e.g., 54V). The HVBP may have the first battery pack interface (e.g., the interface C) that is connectable to the first power tool interface (i.e., the interface C) to provide power to the HPHVPT. The first battery pack interface (e.g., the interface C) of the HVBP is not connectable to the second power tool interface (e.g., the interface B) or the third power tool interface (e.g., the interface A).

The second battery pack may be a multi-voltage capable (low voltage/high voltage battery pack MVBP. The MVBP may have a second battery pack interface (e.g., the interface A/B) that is coupleable to the second power tool interface (e.g., the interface B) of the LPHVPT and that is coupleable to the third power tool interface (i.e., the interface A) of the LVPT.

The MVBP may have the first nominal voltage (e.g., 54V) that is substantially the same as the first power tool rated voltage (e.g., 54V) when the MVBP is coupled to the HPHVPT or connected to the LPHVPT and may have a second nominal voltage (e.g., 18V) that is substantially the same as the third power tool rated voltage (e.g., 18V) when the MVBP is connected to the LVPT. The MVBP may be configured to be coupled to the HPHVPT to provide power to the HPHVPT (e.g., it will require the adaptor to couple the MVBP and the HPHVPT). It is noted that, in the present patent application, the battery and the power tool may be “connected” when there is no adaptor, while the battery and the power tool may be “coupled” when there is an adaptor. The MVBP may also be configured to be connected to the LVPT to provide power to the LVPT.

The CPTS may further comprise an adaptor having a first adaptor interface (e.g., interface C) configured to be connected to the first power tool interface (e.g., the interface C) of the HPHVPT and a second adaptor interface (e.g., interface B) configured to be connected to the second battery pack interface (e.g., the interface A/B) of the MVBP to couple the MVBP to the HPHVPT.

The second battery pack interface (e.g., the interface A/B) of the MVBP is not able to be coupled to the first power tool interface (e.g., the interface C) of the HPHVPT without the adaptor.

The rated voltage of the HPHVPT and the rated voltage of the LPHVPT are the same. The rated voltage of the HPHVPT and the rated voltage of the LPHVPT may be 54V.

The nominal voltage of the HVBP and the nominal voltage of the MVBP may be the same. The nominal voltage of the HVBP and the nominal voltage of the MVBP may be 54V.

The third battery pack may be a single (fixed) voltage (low voltage) battery pack (LVBP). The LVBP may have the second nominal voltage (e.g., 18V) that is substantially the same as the third power tool rated voltage (e.g., 18V). The LVBP may have a third battery pack interface (e.g., the interface A) that is connectable to the third power tool interface (e.g., the interface A) of the third power tool HPHVPT. The third battery pack LVBP may have a third battery pack interface (e.g., the interface A) that is not connectable to the first power tool interface (e.g., the interface C) of the HPHVPT or the second power tool interface (e.g., the interface B) of the LPHVPT.

As used in this application, rated voltage may refer to the advertised voltage, or the operating voltage, depending on the context. The rated voltage may also encompass a single (fixed) voltage, several discrete voltages, or one or more ranges of voltages. As used in the application, rated voltage may refer to any of these types of voltages or a range of any of these types of voltages.

Advertised Voltage: With respect to power tools, battery packs, and chargers, the advertised voltage generally refers to a voltage that is designated on labels, packaging, user manuals, instructions, advertising, marketing, or other supporting documents for these products by a manufacturer or seller so that a user is informed which power tools, battery packs, and chargers will operate with one another. The advertised voltage may include a numeric voltage value, or another word, phrase, alphanumeric character combination, icon, or logo that indicates to the user which power tools, battery packs, and chargers will work with one another. In some embodiments, as discussed below, a power tool, battery pack, or charger may have a single advertised voltage (e.g., 20V or 60V), a range of advertised voltages (e.g., 20V-60V), or a plurality of discrete advertised voltages (e.g., 20V/60V). As discussed further below, a power tool may also be advertised or labeled with a designation that indicates that it will operate with both a DC power supply and an AC power supply (e.g., AC/DC or AC/60V). An AC power supply may also be said to have an advertised voltage, which is the voltage that is generally known in common parlance to be the AC mains voltage in a given country (e.g., 120 VAC in the United States and 220 VAC-240 VAC in Europe).

Operating Voltage: For a power tool, the operating voltage generally refers to a voltage or a range of voltages of AC and/or DC power supply(ies) with which the power tool, its motor, and its electronic components are designed to operate. For example, a power tool advertised as a 120V AC/DC tool may have an operating voltage range of 92V-132V. The power tool operating voltage may also refer to the aggregate of the operating voltages of a plurality of power supplies that are coupled to the power tool (e.g., a 120V power tool may be operable using two 60V battery packs connected in series). For a battery pack and a charger, the operating voltage refers to the DC voltage or range of DC voltages at which the battery pack or charger is designed to operate. For example, a battery pack or charger advertised as a 60V battery pack or charger may have an operating voltage range of 51V-60V. For an AC power supply, the operating voltage may refer either to the root-mean-square (RMS) of the voltage value of the AC waveform and/or to the average voltage within each positive half-cycle of the AC waveform. For example, a 120 VAC mains power supply may be said to have an RMS operating voltage of 120V and an average positive operating voltage of 108V.

Nominal Voltage: For a battery pack, the nominal voltage generally refers to the average DC voltage output from the battery pack. For example, a battery pack advertised as a 60V battery pack, with an operating voltage of 51V-60V, may have a nominal voltage of 54V. For an AC power supply, the operating voltage may refer either to the root-mean-square (RMS) of the voltage value of the AC waveform and/or to the average voltage within each positive half-cycle of the AC waveform. For example, a 120 VAC mains power supply may be said to have an RMS nominal voltage of 120V and an average positive nominal voltage of 108V.

Maximum Voltage: For a battery pack, the maximum voltage may refer to the fully charged voltage of the battery pack. For example, a battery pack advertised as a 60V battery pack may have a maximum fully charged voltage of 60V. For a charger, the maximum voltage may refer to the maximum voltage to which a battery pack can be recharged by the charger. For example, a 60V charger may have a maximum charging voltage of 60V.

It should also be noted that certain components of the power tools, battery packs, and chargers may themselves be said to have a voltage rating, each of which may refer to one or more of the advertised voltage, the operating voltage, the nominal voltage, or the maximum voltage. The rated voltages for each of these components may encompass a single voltage, several discrete voltages, or one or more ranges of voltages. These voltage ratings may be the same as or different from the rated voltage of power tools, battery packs and chargers. For example, a power tool motor may be said to have its own an operating voltage or range of voltages at which the motor is designed to operate. The motor rated voltage may be the same as or different from the operating voltage or voltage range of the power tool. For example, a power tool having a voltage rating of 60V-120V may have a motor that has an operating voltage of 60V-120V or a motor that has an operating voltage of 90V-100V.

The power tools, power supplies, and chargers also may have ratings for features other than voltage. For example, the power tools may have ratings for motor performance, such as an output power (e.g., maximum watts out (MWO) as described in U.S. Pat. No. 7,497,275, which is incorporated by reference herein in its entirety—“the '275 Patent”) or motor speed under a given load condition. In another example, the battery packs may have a rated capacity, which refers to the total energy stored in a battery pack. The battery pack rated capacity may depend on the rated capacity of the individual cells and the manner in which the cells are electrically connected.

This application also refers to the ratings for voltage (and other features) using relative terms such as low, medium, high, and very high. The terms low rated, medium rated, high rated, and very high rated are relative terms used to indicate relative relationships between the various ratings of the power tools, battery packs, AC power supplies, chargers, and components thereof, and are not intended to be limited to any particular numerical values or ranges. For example, it should be understood that a low rated voltage is generally lower than a medium rated voltage, which is generally lower than a high rated voltage, which is generally lower than a very high rated voltage.

Each of the power tools-LVPT, LPHVPT or HPHVPT-may include a housing. Each power tool housing may incorporate components/elements such as a motor and a working element of the power tool. Each of the power tools LVPT, LPHVPT or HPHVPT may also include a motor control circuit and a battery pack interface that are configured to enable operation from one or more DC battery pack power supplies that together have a rated voltage that corresponds to the rated voltage of the power tool. The motor may be any brushed or brushless DC electric motor, including, but not limited to, a permanent magnet brushless DC motor (BLDC), a permanent magnet DC brushed motor (PMDC), an induction motor, a universal motor, etc. The motor control circuit may include a power unit having one or more power switches (not shown) disposed between the power supply and the motor. The power switch may be an electro-mechanical on/off switch, a power semiconductor device (e.g., diode, FET, BJT, IGBT, etc.), or a combination thereof. The motor control circuit may further include a control unit or controller. The control unit may be arranged to control a switching operation of the power switches in the power unit. The motor control circuit may control the motor in fixed or variable speed. The control unit may include a micro-controller or similar programmable module configured to control gates of power switches. Additionally or alternatively, the control unit may be configured to monitor and manage the operation of the DC battery pack power supplies. Additionally or alternatively, the control unit may be configured to monitor and manage various tool operations and conditions.

The LVPT may include, but is not limited to, at least one of the following power tools: a band saws, a chop saw, a circular saw, a cutout tool, a compressor, a drill, a hammer drill, a fan, a grinder, a hammer, a dust extractor, an impact driver, an impact wrench, an inflator, a jigsaw, a joiner, a light, a magnetic drill press, a nailer, an oscillating tool, a planer, a polisher, a ratchet, a reciprocating saw, a rotary hammer, a router, a sander, a screwdriver, a screwgun, a vacuum, a blower, a chain saw, an edger, a hedge trimmer, a pressure washer, a mower, a snow thrower, a string trimmer, a tiller, or an auger. The LVPT may be configured to operate at a rated voltage of 18 V.

The LVPT may be configured to be powered by a single LVBP, which may be charged using an LVC that is designed and configured to charge the LVBP. The LVPT, the LVBP, and the LVC may have the same interface (e.g., the interface A). The interfaces may be configured for electrically and physically coupling the LVBP with the LVPT and/or the LVC.

The LPHVPT may be configured to operate at a rated voltage of 54 V. The power tool interface of the LPHVPT may be referred to as interface B in this patent application. The LPHVPT may include, but is not limited to, at least one of the following power tools: a circular saw, a drill, a grinder, a miter saw, a reciprocating saw, a rotary hammer, or a table saw.

The LPHVPT may be configured to be powered by a MVBP, which may be charged using a LVC. The LVC may be designed and configured to charge either the LVBP or the MVBP. The MVBP may be configured to power either the LVPT or the LPHVPT. The MVBP is also described in detail in U.S. Pat. No. 9,406,915, which is incorporated herein in its entirety.

The MVBP interface may incorporate two interfaces (e.g., the interface A and the interface B). The LPHVPT and the MVBP may both include the same interface (e.g., the interface B). The LVPT and the MVBP may both include the same interface (e.g., the interface A). The iinterface A may be configured for electrically and physically coupling the MVBP with the LVPT and/or LVC and the interface B may be configured for electrically and physically coupling the MVBP with the LPHVPT using the adaptor.

The HPHVPT may be configured to operate at a rated voltage of 54V or higher. The power tool interface of the HPHVPT may be referred to as the interface C in this patent application. The HPHVPT may include, but is not limited to, at least one of the following power tools: a jack hammer a concrete drill, a concrete saw, a 12 inch cut-off saw, a concrete vibrator, a plate/concrete plate compactor, a rammer, or a screed/concrete screed. Such HPHV power tools are also described in detail in U.S. Patent Application Publication Number 2023-0291049, which is incorporated herein in its entirety. These power tools may require a relatively high amount of power and/or runtime compared to the LPHVPT. The HPHVPT may also include, but is not limited to, a concrete mixer, a jobsite lift, a block saw, a concrete finisher, an early entry saw, and a jobsite buggy, they may be referred to as very high power tools. These power tools may have the relatively high operating voltage. These power tools may require a relatively high amount of power and/or runtime compared to the LPHVPT.

The HPHVPT may be configured to be powered by a HVBP, which may be charged using a HVC that is designed and configured to charge the HVBP. The HPHVPT, the HVBP, and the HVC may have the same interface (e.g., the interface C). The interfaces may be configured for electrically and physically connecting the HVBP with the HPHVPT and/or the HVC.

However, it will be understood by those skilled in the art that the teachings of the present patent application are not so limited.

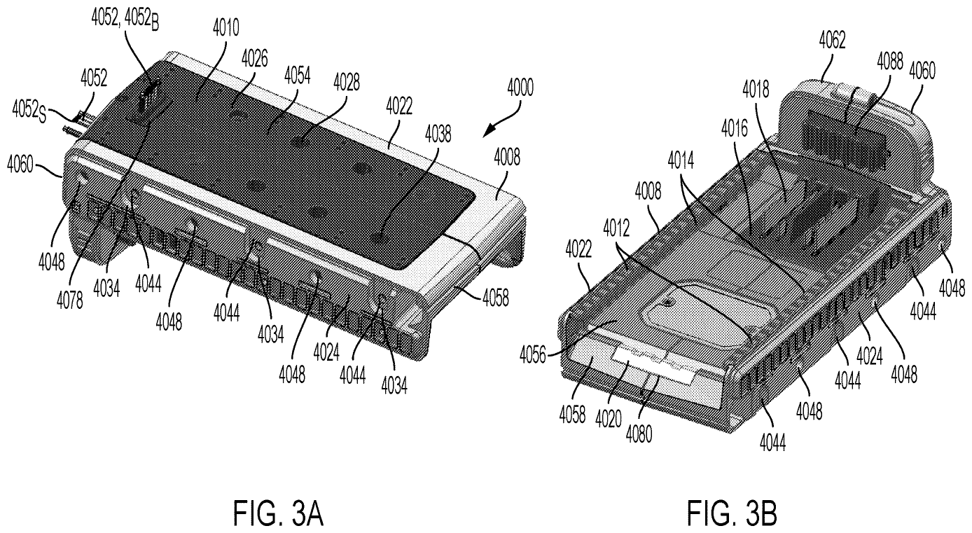

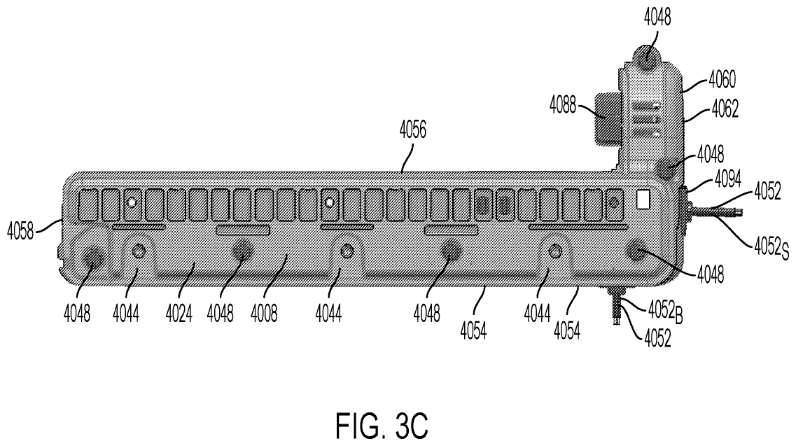

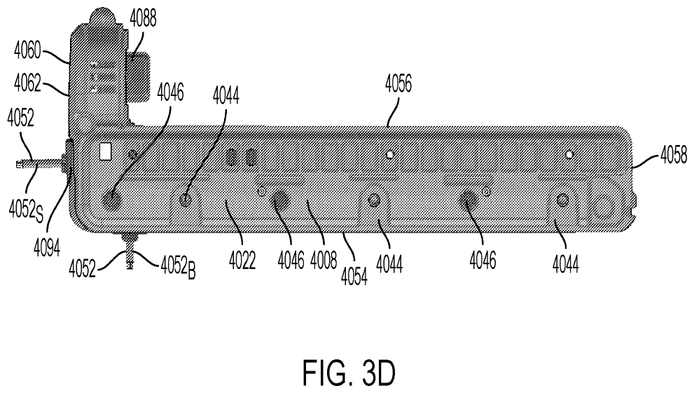

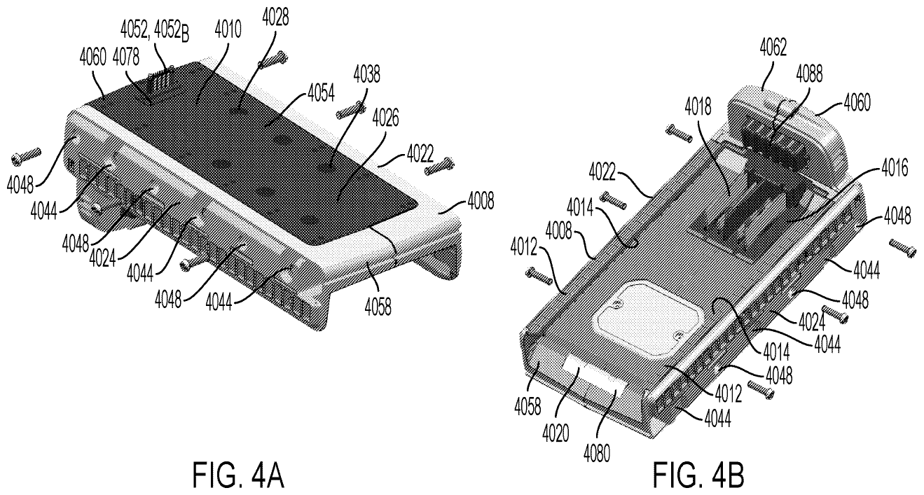

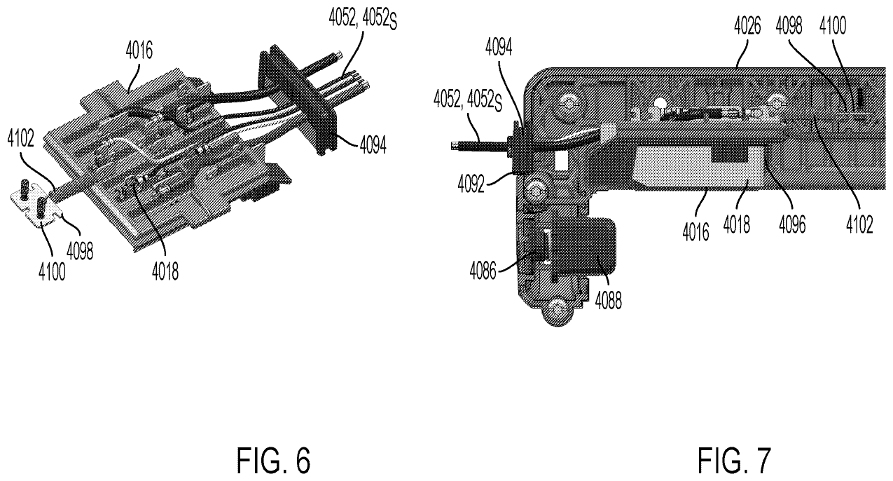

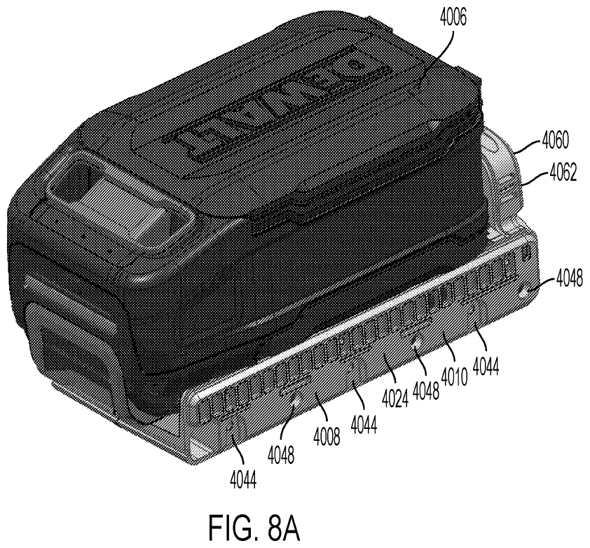

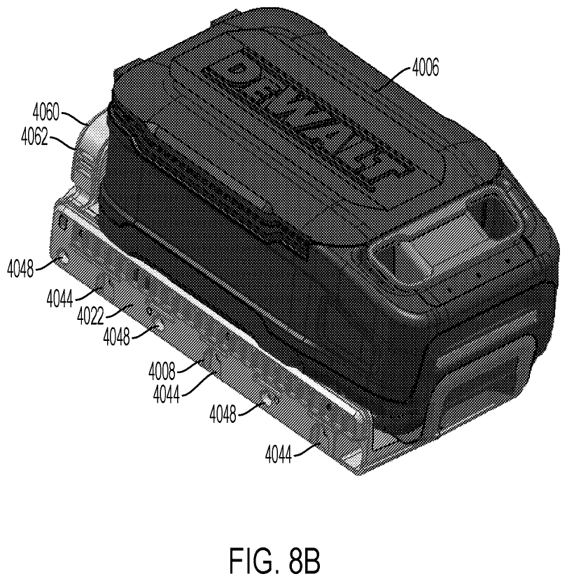

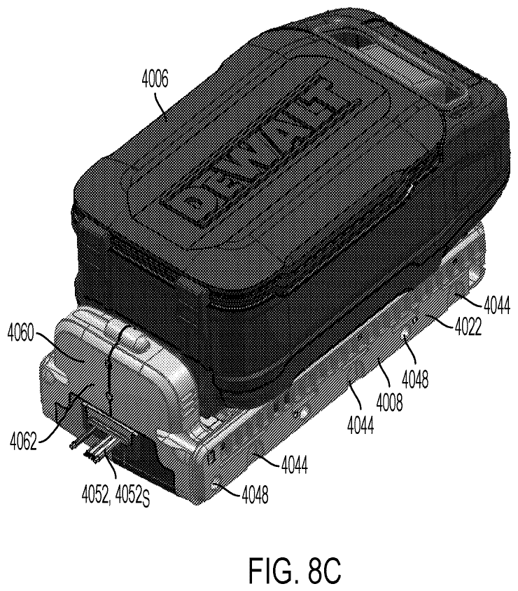

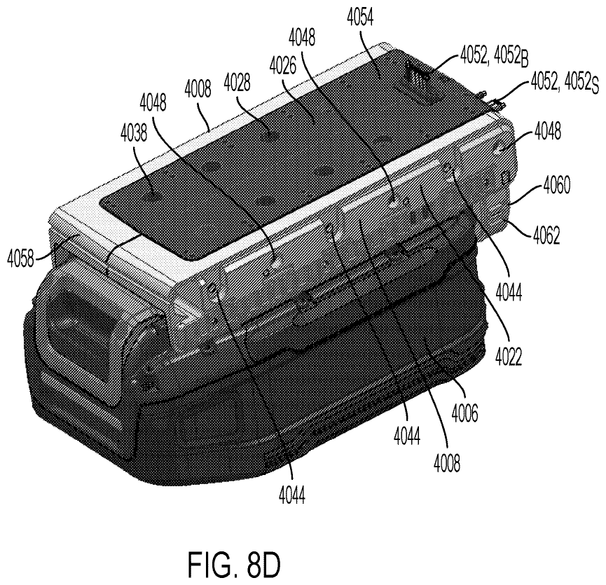

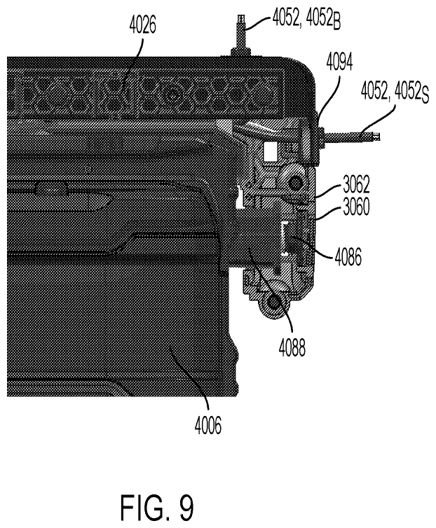

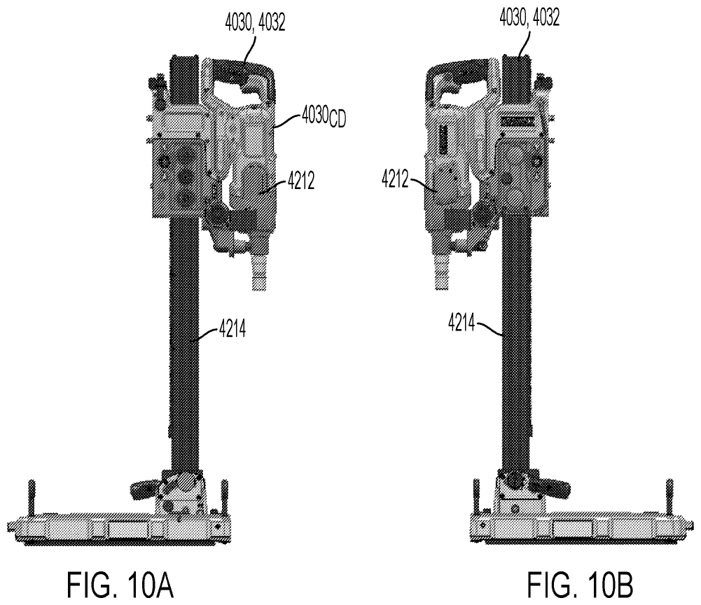

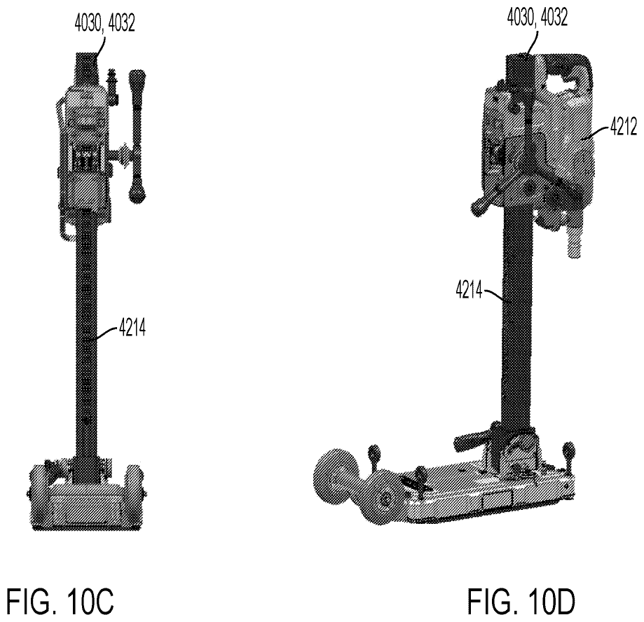

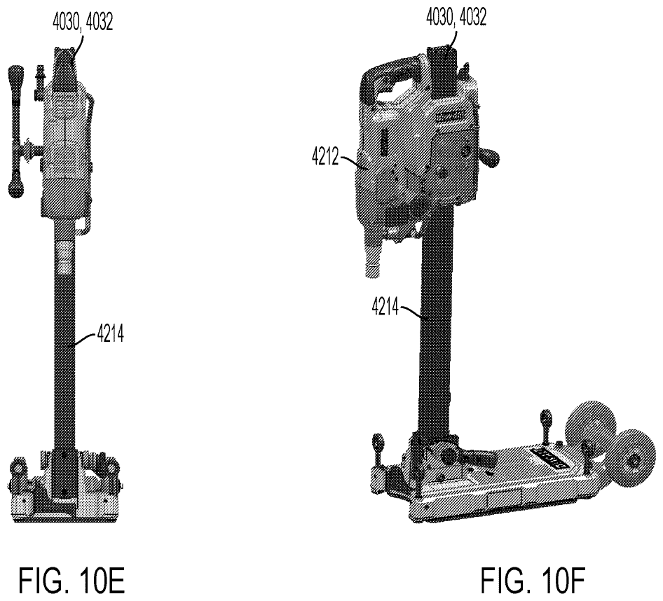

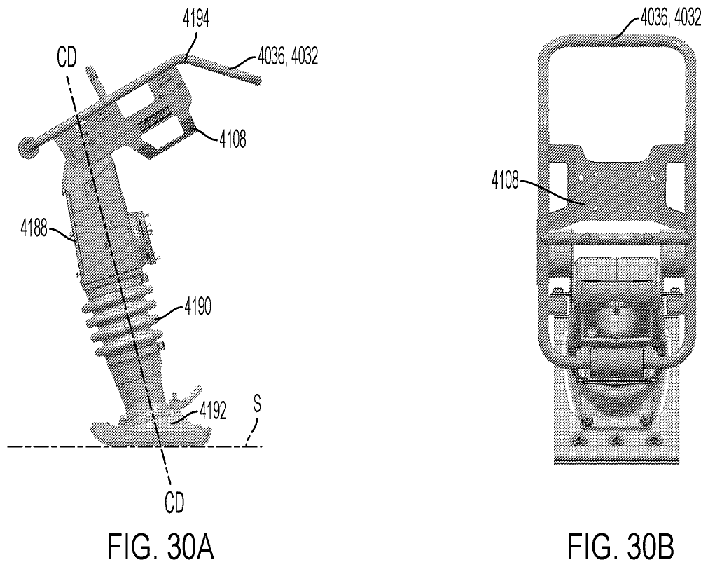

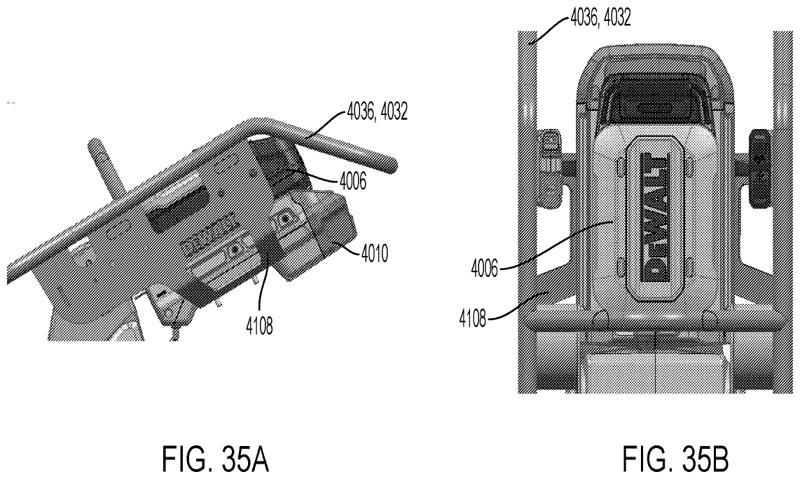

Referring to FIGS. 3A-38, the present patent application provides an interface system 4000 for enabling mating and operation between a set of cordless power tools 4032 and a battery pack 4006. The interface system 4000 comprises a housing 4008. The housing 4008 includes an interface 4010 for mating with the battery pack 4006. For example, the interface 4010 may be configured to enable the battery pack 4006 to be coupled to a cordless power tool 4030, 4036 in multiple orientations. The interface 4010 may include a set of rails 4012, a set of grooves 4014, a terminal block 4016 including a set of terminals 4018, and a catch 4020. The housing 4008 includes a first attachment feature 4028 configured to attach the housing 4008 to a first cordless power tool 4030 of the set of cordless power tools 4032 in a first orientation (as shown in FIGS. 10A-22) and a second attachment feature 4034 (as shown in FIG. 3A) configured to attach the housing 4008 to a second cordless power tool 4036 of the set of cordless power tools 4032 in a second orientation (as shown in FIGS. 30A-35B).

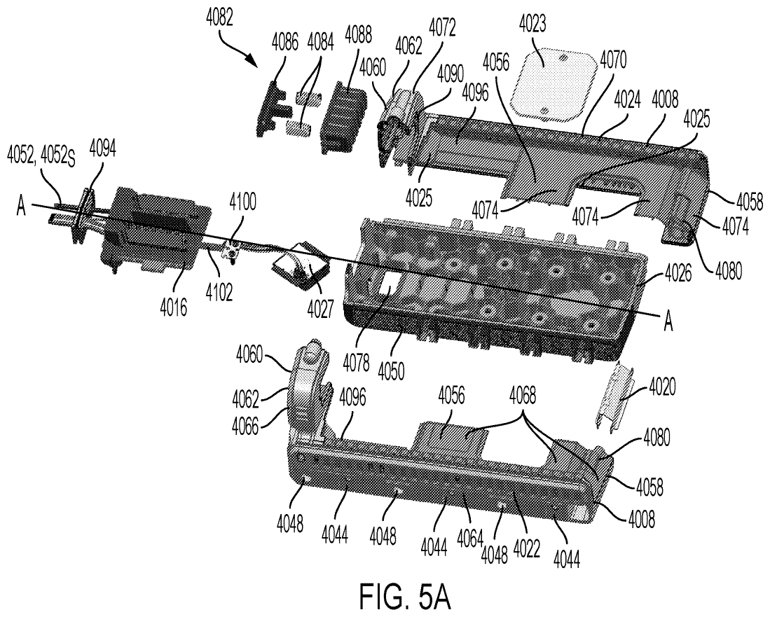

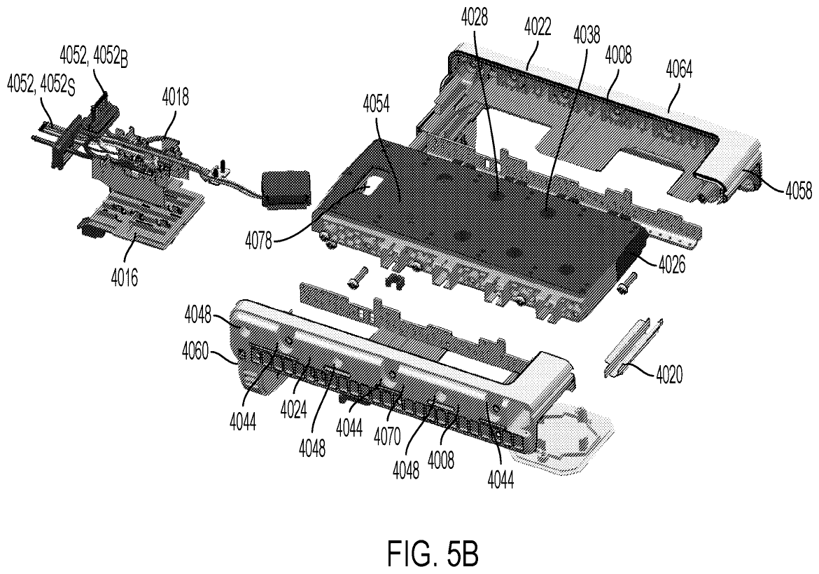

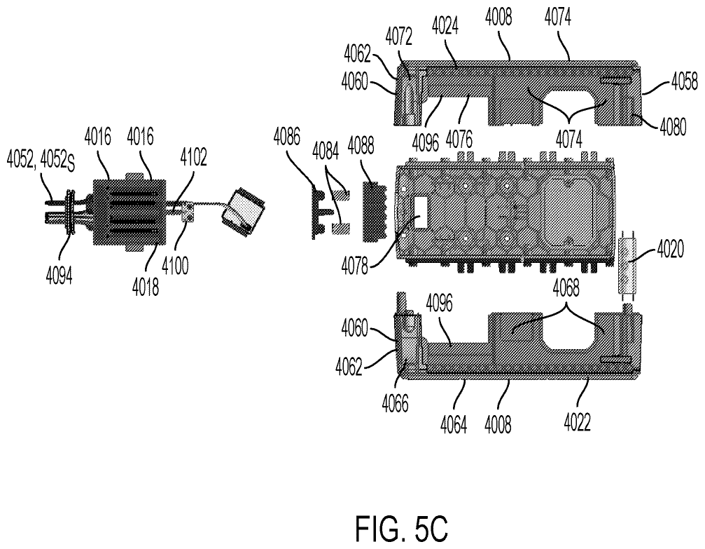

As shown in FIG. 5A, the housing 4008 may include a first housing portion 4022 and a second housing portion 4024 forming an internal cavity 4025. In one embodiment, the internal cavity may simply be an opening 4025. The housing 4008 may also include a core block 4026. The core block 4026 may be positioned in the internal cavity of the housing 4008. The core block 4026 may be positioned between the first housing portion 4022 and the second housing portion 4024. The first and second housing portions 4022, 4024 and the core block 4026 may be made of Acrylonitrile Butadiene Styrene (ABS) material. The first and second housing portions 4022, 4024 and the core block 4026 may be made of a high/hard impact plastic material.

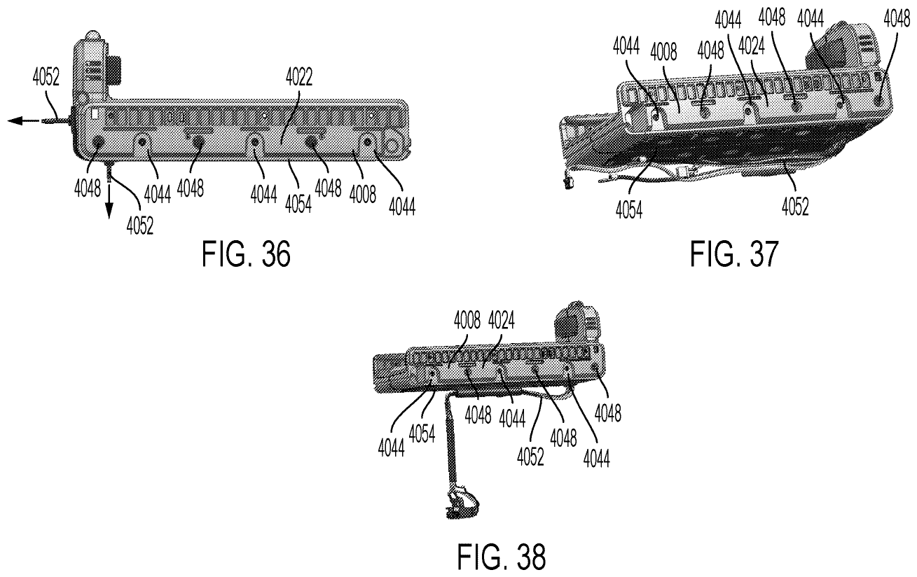

One of the first housing portion 4022 and the second housing portion 4024 may be a right side housing portion and the other of the first housing portion 4022 and the second housing portion 4024 may be a left side housing portion. In another embodiment, the first housing portion 4022 and the second housing portion 4024 may be upper and lower housing portions. In such an embodiment, the upper and lower housing portions may be configured such that the first attachment feature 4028 (e.g., a set of holes 4038 in the core block 4026) may still remain exposed to mate with a corresponding fixture 4040 on the first cordless power tool 4030 and such that a wire harness 4052, 4052B (if/when present) may extend outwardly and away from the interface 4010 so as to engage with a corresponding electrical interface of the first cordless power tool 4030. FIG. 36 shows a first example wiring scheme of the interface 4010. FIG. 37 shows a second example wiring scheme of the interface 4010. FIG. 38 shows a third example wiring scheme of the interface 4010.

One of the set of grooves 4014 and one of the set of rails 4012 may be formed on the first housing portion 4022. Another of the set of grooves 4014 and another of the set of rails 4012 may be formed on the second housing portion 4024. In another embodiment, one of the set of grooves 4014 and one of the set of rails 4012 may be formed on one side of the core block 4026 and another of the set of grooves 4014 and another of the set of rails 4012 may be formed on the other side of the core block 4026.

The first housing portion 4022 may include a first side housing portion 4064, a first rear housing portion 4066, and may also include a first top housing portion 4068. The second housing portion 4024 may include a second side housing portion 4070, a second rear housing portion 4072, and may also include a second top housing portion 4074.

The first and second rear housing portions 4066, 4072 may together form an internal cavity to receive an assembly 4082 and support 4094 for the wire harness 4052, 4052S. The assembly 4082 may include a pair of springs 4084, a springs support 4086 and a portion 4088. The first and second rear housing portions 4066, 4072 may include openings 4090 to allow the portion 4088 to extend therethrough. These components (i.e., the spring system including the pair of springs 4084, the springs support 4086 and the portion 4088) may be configured to assist in ejection of the battery pack 4006 once the latch is released. The first and second rear housing portions 4066, 4072 may also include openings/recesses to allow the support 4094 for the wire harness 4052, 4052S extend therethrough.

The first and second top housing portions 4068, 4074 may together provide a battery pack interface surface 4056. The battery pack interface surface 4056 may be configured to engage with/receive the battery pack 4006 thereon when the battery pack 4006 is engaged with the interface 4010. The battery pack interface surface 4056 may be part of the first and the second housings 4022 and 4024. The battery pack interface surface 4056 may be part of the core block 4026. The first and second top housing portions 4068, 4074 may include openings 4076 for the terminal block 4016 to extend therethrough. The first and second top housing portions 4068, 4074 may include openings/recesses 4080 for the catch 4020. The side, rear and top housing portions of each first and second housing portions may be integrally formed as a single piece housing portion assembly.

The terminal block 4016 including the set of terminals 4018 may be coupled to or disposed on or in the core block 4026. The terminal block 4016 may be configured to engage with a terminal block of the battery pack 4006 to electrically couple the battery pack 4006 to the interface 4010. The set of terminals 4018 of the interface 4010 may include two power terminals and a plurality of signal terminals. The plurality of signal terminals may include five signal terminals. The number of signal terminals may vary.

The catch 4020, coupled to the interface 4010 may be configured to engage with a latch disposed on the battery pack 4006. In another embodiment, the interface 4010 may include a latch that may be configured to engage with a catch disposed on the battery pack 4006. The latch may be configured to move into and out of a cavity of the battery pack upon depression of a user actuated latch button. The latch may be configured to be received in the catch when the battery pack 4006 is fully engaged with/coupled to the interface 4010. In order to disengage/decouple the battery pack 4006 from the interface 4010, the user actuated latch button is depressed to release the latch from the catch. The battery pack 4006 can then be removed from the interface 4010.

The interface 4010 may include the wire harness 4052 that is configured to be electrically coupled to either the first cordless power tool 4030 or the second cordless power tool 4036. There are two wire harnesses 4052_{B} and 4052_{S} shown in the illustrated embodiments. In one embodiment the interface 4010 may only include wire harnesses 4052_{B}. In another embodiment, the interface 4010 may only include wire harnesses 4052_{S}. In yet another embodiment, the interface 4010 may include two wire harnesses 4052_{B} and 4052_{S}.

The core block 4026 may include a tool interface surface 4054. The tool interface surface 4054 may be disposed opposing the battery pack interface surface 4056. The wire harness 4052, 4052_{B} may be configured to extend from the tool interface surface 4054. The tool interface surface 4054 may include an opening 4078 that is configured to allow the wire harness 4052, 4052_{B} to extend therethrough.

The interface 4010 may also include a front portion 4058 and a rear portion 4060. The catch 4020 may be disposed in the front portion 4058 of the interface 4010. The wire harness 4052 may be configured to extend from a rear surface 4062 of the rear portion 4060 of the interface 4010.

The interface 4010 may include receiving portions 4096 to receive the terminal block 4016 therein. The interface 4010 may also receive a terminal block positioning assembly 4098. The terminal block positioning assembly 4098 may include a bracket/support member 4100 that is fixedly attached to the core block 4026 and a spring 4102 that connects the terminal block 4016 to the bracket/support member 4100 so as to position the terminal block 4016 with respect to the core block 4026.

Referring to FIG. 5A, a communication module 4027 may be provided. The communication module 4027 may be a Bluetooth Low Energy Module (BLEM). The BLEM 4027 may be configured to function as a communications module between the interface and a hub/a tool/a battery pack. A cover 4023 may be configured to cover the BLEM 4027.

The battery pack 4006 may include a slide-type battery pack. For example, the battery pack 4006 may include a set of rails (one rail on each side of the battery pack 4006), a set of grooves (one on each side of the battery pack 4006) and a latch mechanism to secure the battery pack 4006 with the interface 4010.

The grooves 4014 of the interface 4010 may be configured to receive corresponding rails of the battery pack 4006 and the rails 4012 of the interface 4010 may be configured to be received in corresponding grooves of the battery pack 4006 when the battery pack 4006 slidingly engages/couples with the interface 4010. That is, the set of rails and the set of grooves of the battery pack 4006 may be configured to engage with a set of grooves 4014 and the set of rails 4012 of the interface 4010 to mechanically couple the battery pack 4006 and the interface 4010 together.

The battery pack may have a capacity of 10 Ah, an impedance of equal to or less than approximately 3 milliohms, and a nominal voltage of 54V.

The core block 4026 may include the first attachment feature 4028. The first attachment feature 4028 may include the set of holes 4038 in the core block 4026 configured to mate with a corresponding fixture 4040 on the first cordless power tool 4030.

The first and second housing portions 4022, 4024 may be attached to the core block 4026 such that the set of holes 4038 in the core block 4026 may remain exposed to mate with the corresponding fixture 4040 on the first cordless power tool 4030. The fixture 4040 on the first cordless power tool 4030 may include protrusions 4042 that are configured to align with and to be received in the set of holes 4038 in the core block 4026. The pattern of the protrusions 4042 on the fixture 4040 on the first cordless power tool 4030 may correspond to the pattern of the set of holes 4038 in the core block 4026. Mechanical fasteners (e.g., screws 4104, etc.) may be inserted though the set of holes 4038 in the core block 4026 and the protrusions 4042 on the fixture 4040 on the first cordless power tool 4030 after they are aligned, for connecting the core block 4026 to the fixture 4040 on the first cordless power tool 4030 and therein affixes the core block 4026 to the first cordless power tool 4030.

The set of holes 4038 in the core block 4026 are shown to have a circular shaped configuration and the protrusions are shown to have a corresponding shaped configuration. A person of ordinary skill in the art would readily appreciate that the set of holes 4038 in the core block 4026 and the protrusions 4042 in the fixture 4040 on the first cordless power tool 4030 may have corresponding shaped configurations. In another embodiment, the fixture 4040 on the first cordless power tool 4030 may include other (having different shapes, configurations, etc.) engagement portions that are configured to align and engage with corresponding engagement portions in the core block 4026. In the illustrated embodiment, the number of holes in the set of holes 4038 in the core block 4026 may be eight, and the number of protrusions 4042 on the fixture 4040 on the first cordless power tool 4030 may be six (two holes in the core block 4026 may be left unused during use). The number of holes in the set of holes 4038 in the core block 4026 and the number of protrusions 4042 on the fixture 4040 on the first cordless power tool 4030 may vary and may depend on the power tool.

The second attachment feature 4034 may include a set of holes 4044 in the housing 4008 configured to mate with a corresponding fixture 4046 on the second cordless power tool 4036. The corresponding fixture 4046 on the second cordless power tool 4036 may be a frame 4108. The frame 4108 may include openings. The pattern of the openings on the fixture 4046 on the second cordless power tool 4036 may correspond to the pattern of the set of holes 4044 in the housing 4008. Mechanical fasteners (e.g., screws, etc.) may be inserted though the holes 4044 in the housing 4008 and the openings on the fixture 4046 on the second cordless power tool 4036 after they are aligned, for connecting the interface 4010 to the fixture 4046 on the second cordless power tool 4036 and therein affixes the core block 4026 to the second cordless power tool 4036.

The set of holes 4044 in the housing 4008 is a first set of holes 4044. The first set of holes 4044 may be formed in the first and second housing portions 4022, 4024.

The holes 4044 in the housing 4008 are shown to have a circular shaped configuration and openings on the fixture 4046 on the second cordless power tool 4036 are shown to have a corresponding shaped configuration. A person of ordinary skill in the art would readily appreciate that the holes 4044 in the housing 4008 may have any other corresponding shaped configurations. In another embodiment, the fixture 4046 on the second cordless power tool 4036 may include other (having different shapes, configurations, etc.) engagement portions that are configured to align and engage with corresponding engagement portions in each of the first and second housing portions 4022, 4024. In the illustrated embodiment, the number of holes in each of the first and second housing portions 4022, 4024 may be three. The number of holes in each of the first and second housing portions 4022, 4024 and the number of openings on the fixture 4046 on the second cordless power tool 4036 may vary and may depend on the power tool.

The housing 4008 may also include a second set of holes 4048 that are configured to engage with a corresponding set of holes 4050 in the core block 4026 so as to connect the core block 4026 to the housing 4008.

The first cordless power tool 4030 of the set of cordless power tools 4032 may include a concrete or a core drill system 4030CD. The first cordless power tool 4030 may be a cordless core drill system 4030CD. The drill may be configured to be attached to a stand and the interface/battery pack may be configured to be attached to the stand. That is, the drill may be configured to electrically and mechanically attach to the stand on one side and the battery pack (or a different battery pack along with an adaptor) may be configured to attach to the stand on an opposing side. Referring to FIG. 10A, the cordless drill system 4030CD comprises a drill 4212 and a drill stand 4214. The drill 4212 may include an electric motor, a transmission driven by the motor, and an output spindle rotatable by the transmission. The cordless drill system 4030CD may also include a tool bit holder coupled to the output spindle and configured to retain a drill bit therein. A battery pack 4006 may be configured to be coupleable to the battery pack interface 4010 for providing power to the motor. The drill may be configured to be removably coupleable to the stand 4214. The stand 4214 may be configured to move the drill in a manner similar to a drill press.

In the first orientation, the interface 4010 may be positioned in a generally vertical orientation. That is, the interface 4010 may be positioned to be generally parallel to a vertical axis. In the first orientation, a battery pack insertion direction (i.e., the direction in which the battery pack 4006 is inserted into the interface 4010) may be parallel to the generally vertical orientation of the interface 4010.

The procedures in which the interface 4010 may be attached to the first cordless power tool 4030 are shown and explained with respect to FIGS. 10A-22. In these procedures, the core block 4026 is first attached/connected to the fixture 4044 of the stand 4212. The remainder of the interface 4010 is then assembled by (a) positioning and attaching the terminal block 4016 and other electronic components to the core block 4026 that is already attached/connected to the fixture 4044 of the first cordless power tool 4030, and (b) coupling the first and second housing portions 4022, 4024 to the core block 4026 one after the other while the core block 4026 is still connected to the fixture 4044 of the first cordless power tool 4030.

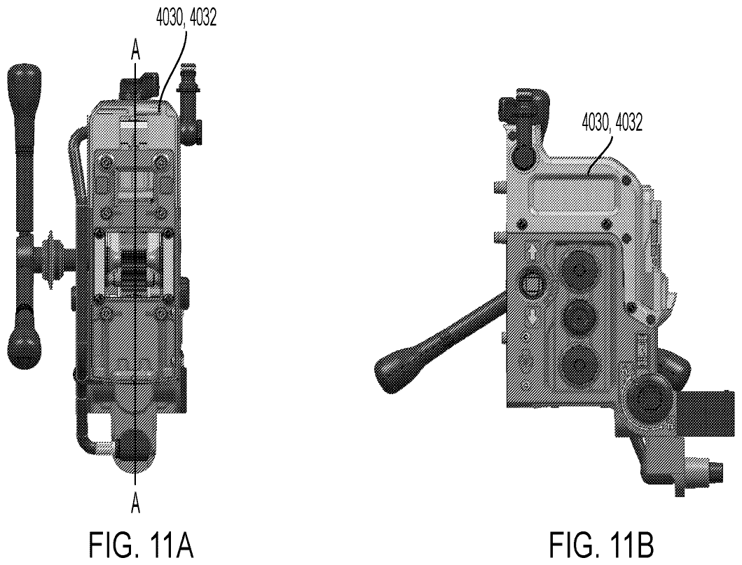

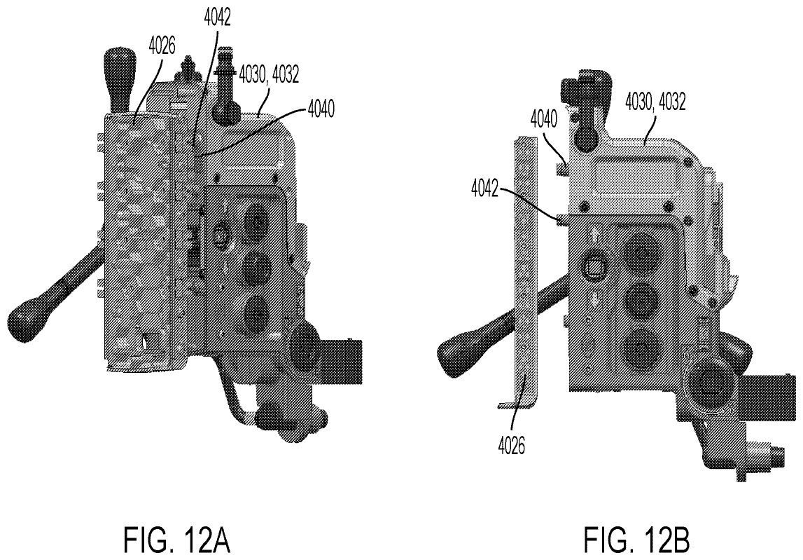

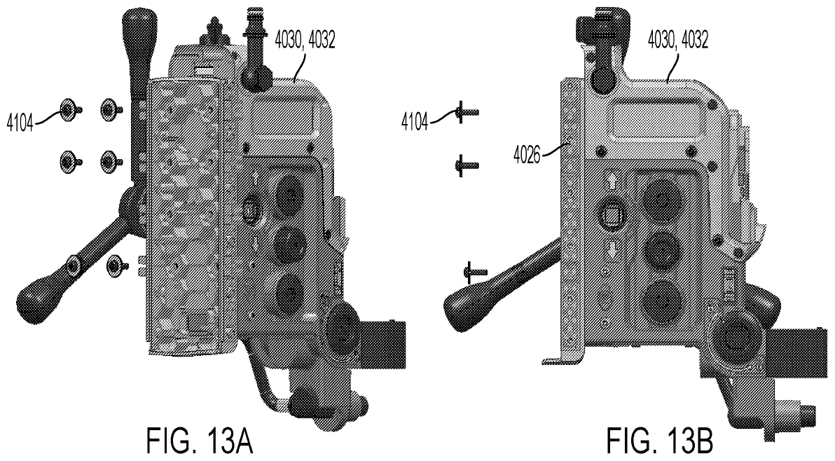

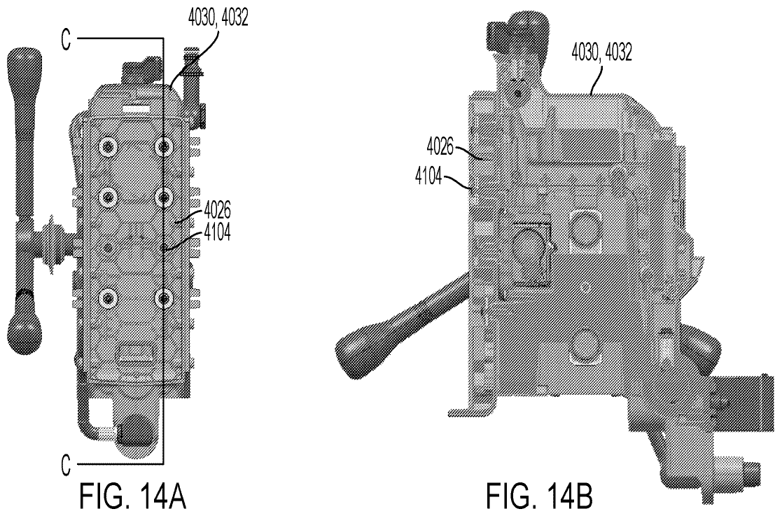

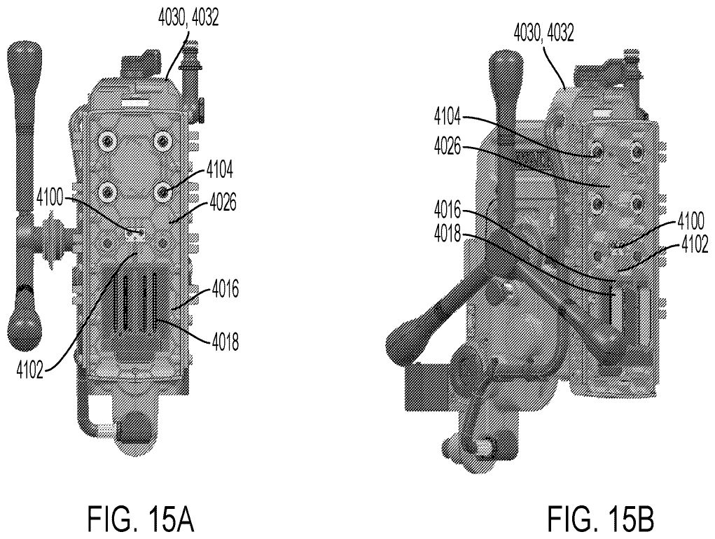

FIGS. 10A-10F and 11A and 11B show various views (some detailed views) of the first cordless power tool 4030. FIGS. 12A and 12B show the core block 4026 of the interface 4010 separated from and before being coupled to the first cordless power tool 4030. FIGS. 13A and 13B show various views of the core block 4026 mated to the first cordless power tool 4030. The protrusions 4042 on the fixture 4040 on the first cordless power tool 4030 may be configured to align with and to be received in the set of holes 4038 in the core block 4026. FIGS. 14A and 14B show various views of the core block 4026 fastened (e.g., via fasteners 4104) to the first cordless power tool 4030. That is, the fasteners 4104 may be inserted through the set of holes 4038 in the core block 4026 and the protrusions 4042 on the fixture 4040 on the first cordless power tool 4030 after they are aligned, for connecting the core block 4026 to the fixture 4040 on the first cordless power tool 4030. FIGS. 15A and 15B show various views of the terminal block 4016 (and the terminals 4018) coupled to the core block 4026. The terminal block positioning assembly 4098 (including the bracket/support member 4100 that is fixedly attached to the core block 4026, and the spring 4102 that connects the terminal block 4016 to the bracket/support member 4100) may be used to position the terminal block 4016 with respect to the core block 4026.

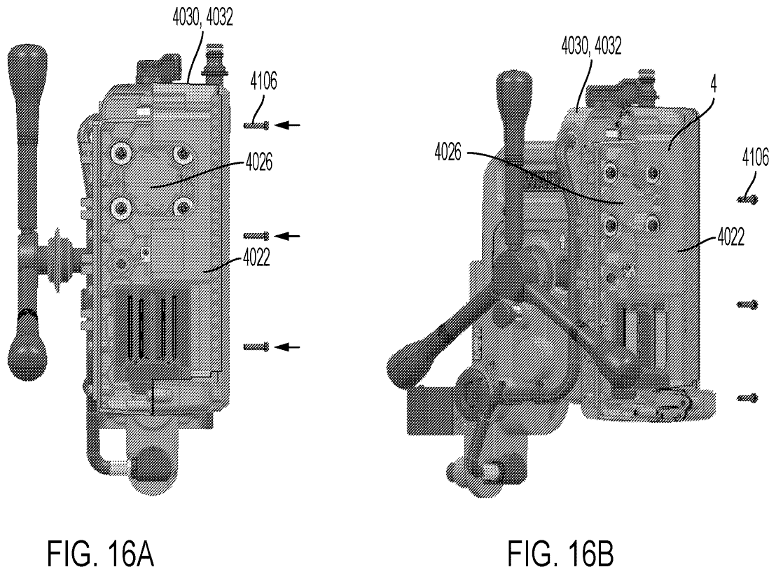

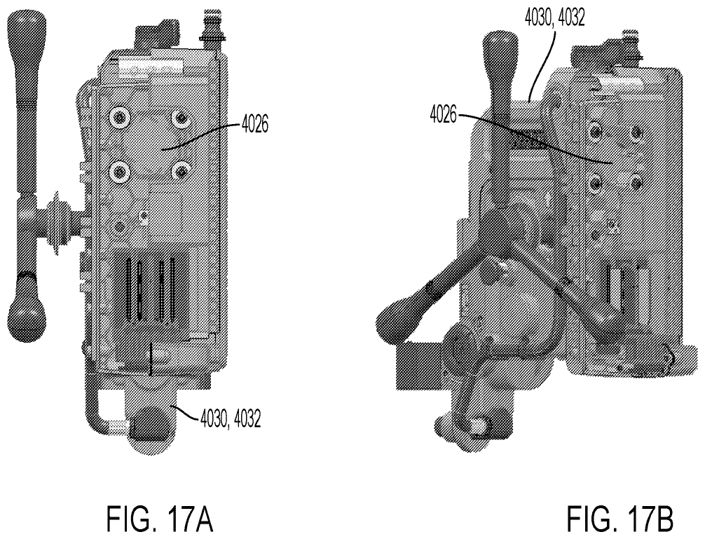

FIGS. 16A and 16B show various views of one of the first and second housing portions 4022, 4024 mated to the core block 4026. FIGS. 17A and 17B show various views of one of the first and second housing portions 4022, 4024 fastened to the core block 4026. The second set of holes 4048 of one of the first and second housing portions 4022, 4024 may be configured to align with the corresponding set of holes 4050 in the core block 4026 so as to connect the core block 4026 to one of the first and second housing portions 4022, 4024. Fasteners 4106 may be inserted through the second set of holes 4048 of one of the first and second housing portions 4022, 4024 and the corresponding set of holes 4050 in the core block 4026 after they are aligned, for connecting the core block 4026 to one of the first and second housing portions 4022, 4024.

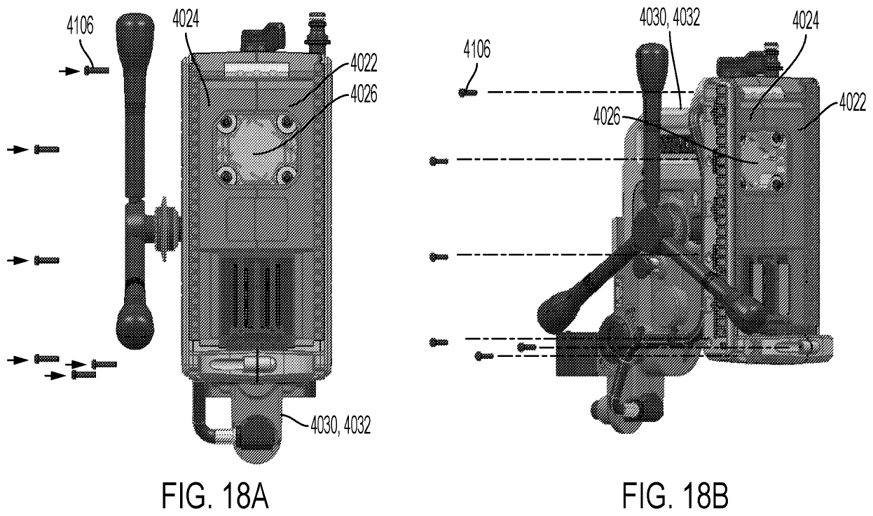

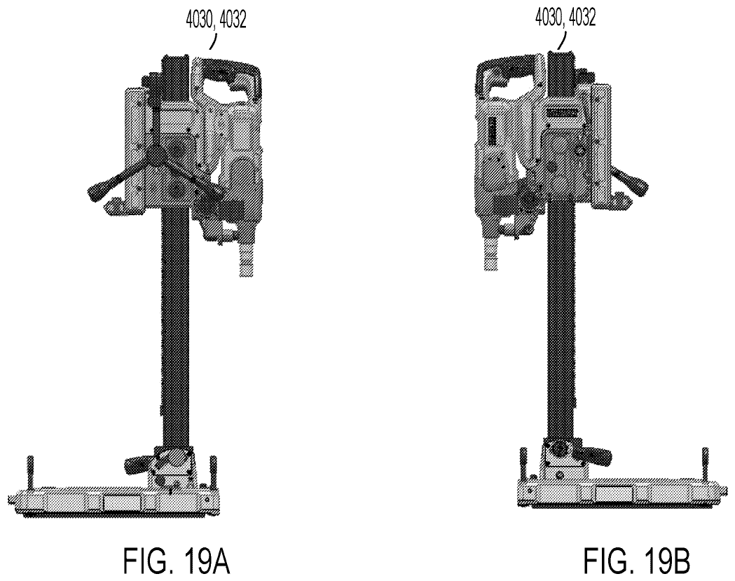

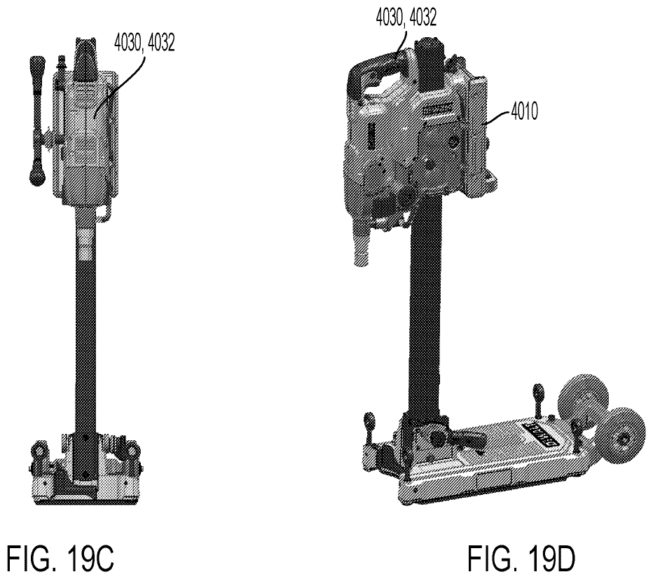

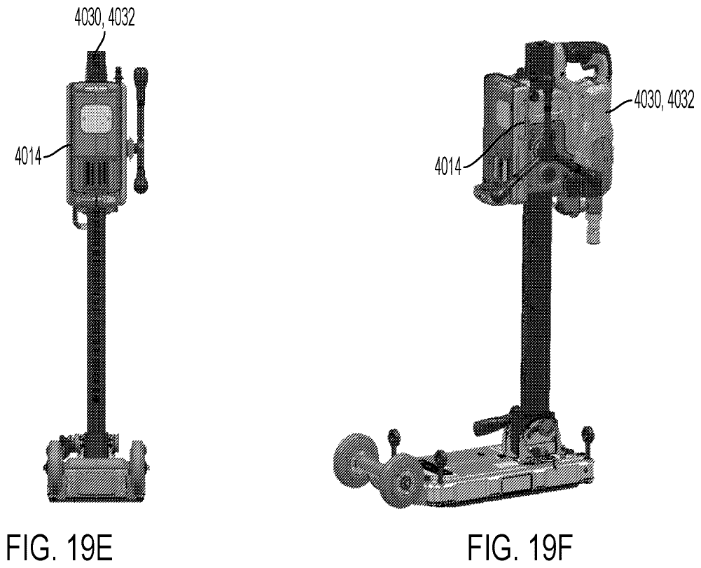

FIGS. 18A and 18B show various views of the other of the first and second housing portions 4022, 4024 mated to the core block 4026. The second set of holes 4048 of the other of the first and second housing portions 4022, 4024 may be configured to align with the corresponding set of holes 4050 in the core block 4026 so as to connect the core block 4026 to the other of the first and second housing portions 4022, 4024. Fasteners 4106 may be inserted through the second set of holes 4048 of the other of the first and second housing portions 4022, 4024 and the corresponding set of holes 4050 in the core block 4026 after they are aligned, for connecting the core block 4026 to the other of the first and second housing portions 4022, 4024. FIGS. 19A-19F show various views of the interface 4010 fastened to the first cordless power tool 4032.

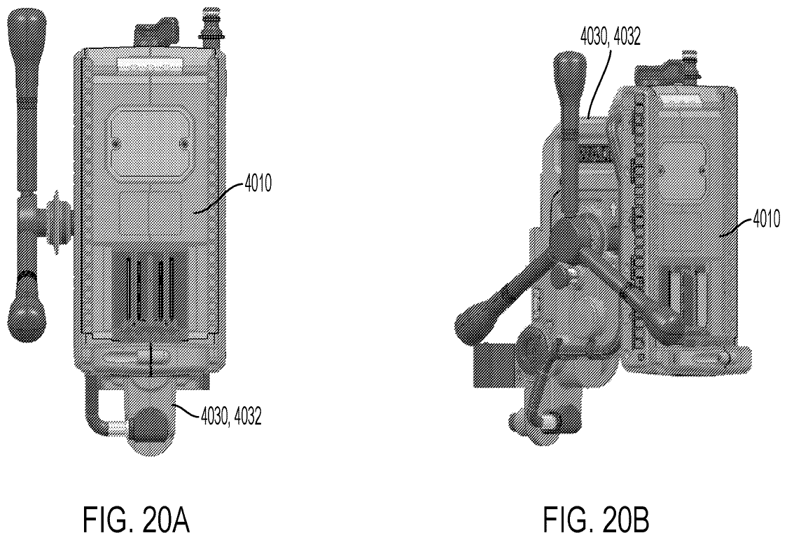

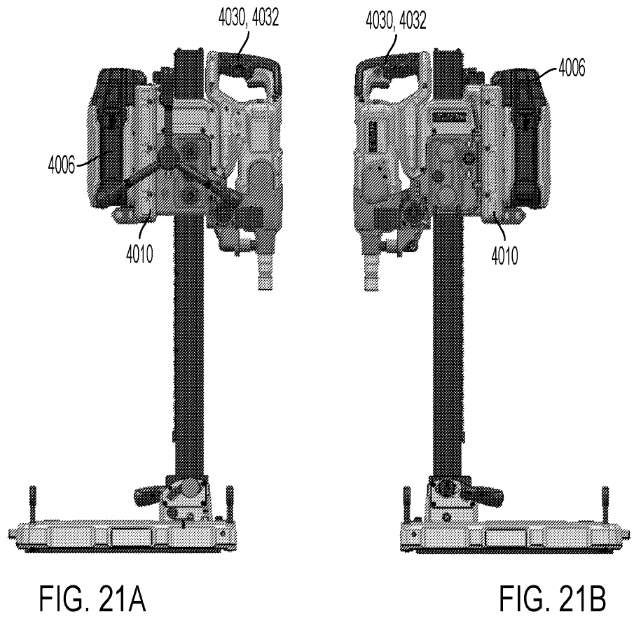

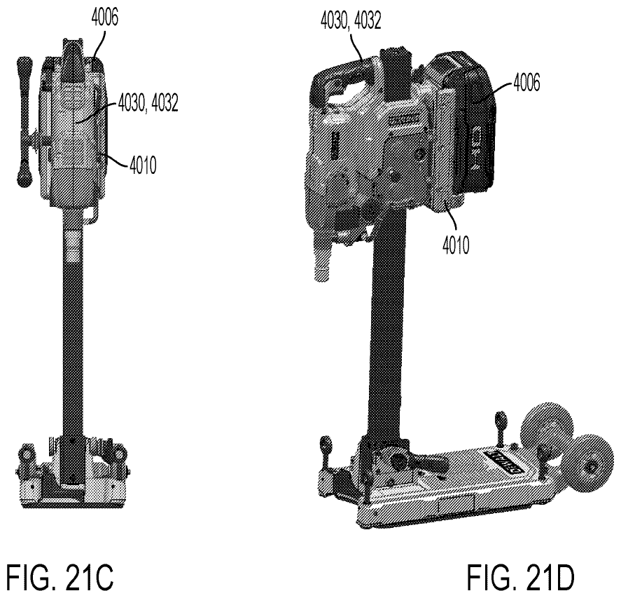

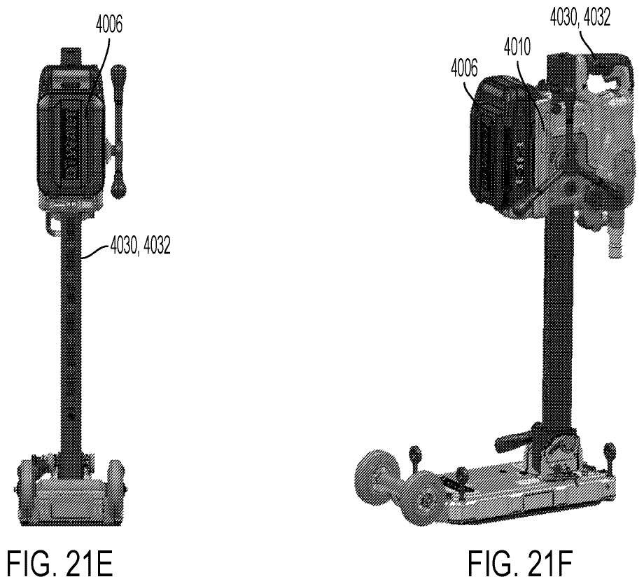

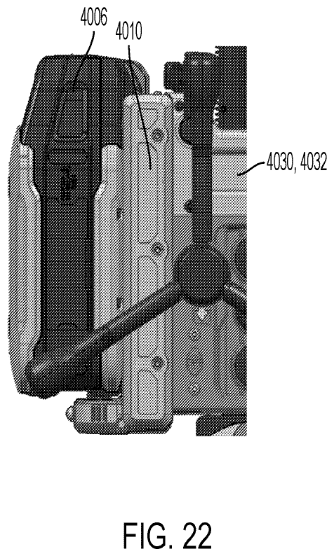

FIGS. 20A and 20B show various detailed views of the interface 4010 fastened to the first cordless power tool 4030. FIGS. 21A-21F show various views of the battery pack 4006 coupled to the interface 4010 and the first cordless power tool 4030. FIG. 22 shows a detailed view of the battery pack 4006, the interface 4010 and the first cordless power tool 4030.

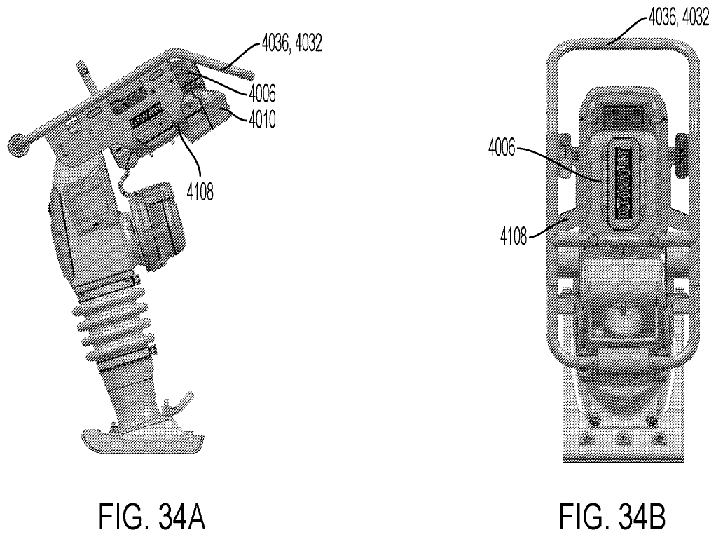

The second cordless power tool 4036 of the set of cordless power tools 4032 may include a rammer 4036R. Referring to FIG. 30A, the rammer (or electric rammer) 4036R may include a primary housing 4188 and a reciprocating leg portion 4190 which may be coupled to a compacting foot 4192. The compacting foot 4192 may be adapted for compacting soil, hardcore, asphalt or any other material S to be compacted. The reciprocating leg portion 4190 may include a reciprocating mechanism (not shown) which is arranged to drive the compacting foot 4192 up and down along the longitudinal axis CD-CD of the power tool 4036R. The rammer 4036R may include a handle 4194 by which a user can maneuver the rammer 4036R, and the battery pack 4006 (as shown in FIG. 34A-34B) for powering the electric motor (not shown but located within the primary housing 4188) of the rammer 4036R.

In the second orientation, the interface 4010 may be positioned in a generally horizontal orientation. In the second orientation, the interface 4010 may be positioned in a generally angled orientation with respect to the vertical axis and a horizontal axis. The horizontal axis may generally be parallel to the ground or surface on which the power tool is disposed. The vertical axis may generally be perpendicular to the horizontal axis.

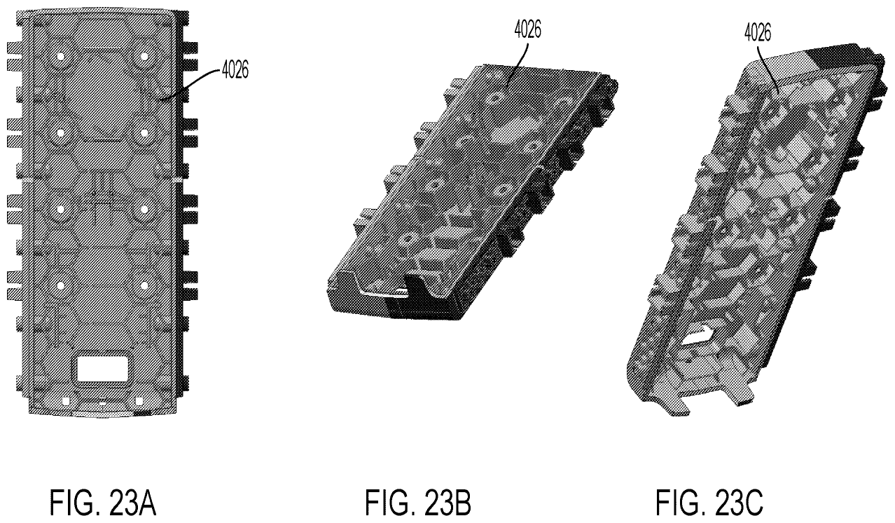

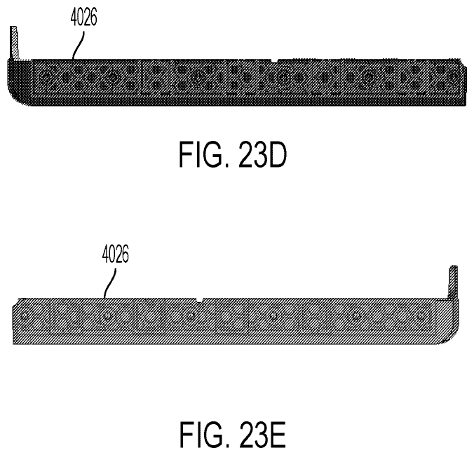

The procedures in which the interface 4010 may be attached to the second cordless power tool 4036 are shown and explained with respect to FIGS. 23A-35B. In these procedures, the interface 4010 is first assembled by (a) disposing the core block 4026, (b) positioning and placing the terminal block 4016 and other electronic components on the core block 4026, (c) coupling the first and second housing portions 4022, 4024 to the core block 4026 one after the other, and (d) connecting the assembled interface 4010 to the second cordless power tool 4036. This second method of attachment is different from the first method of attachment shown and explained with respect to FIGS. 10A-22 in which the core block 4026 is first attached to the fixture of the power tool. The interface 4010 is then assembled on the core block 4026 while the core block 4026 that is attached to the fixture of the power tool.

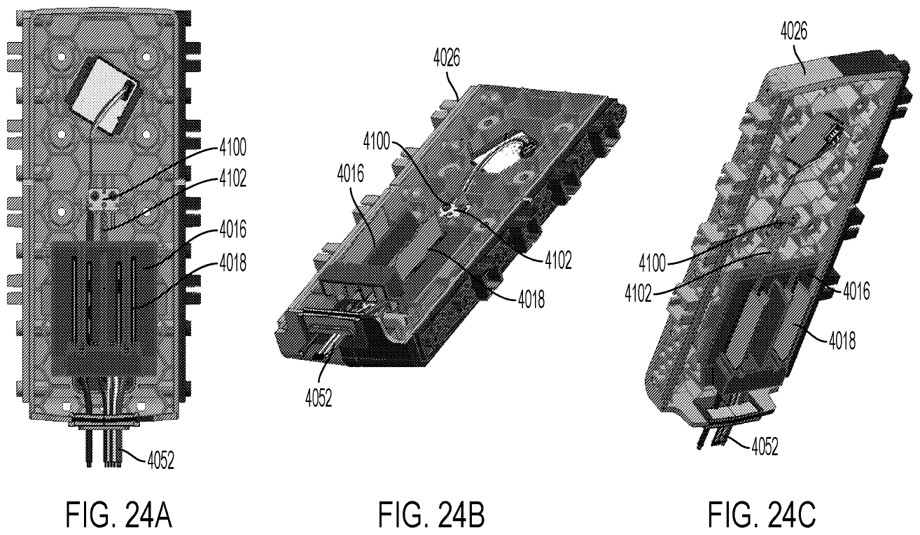

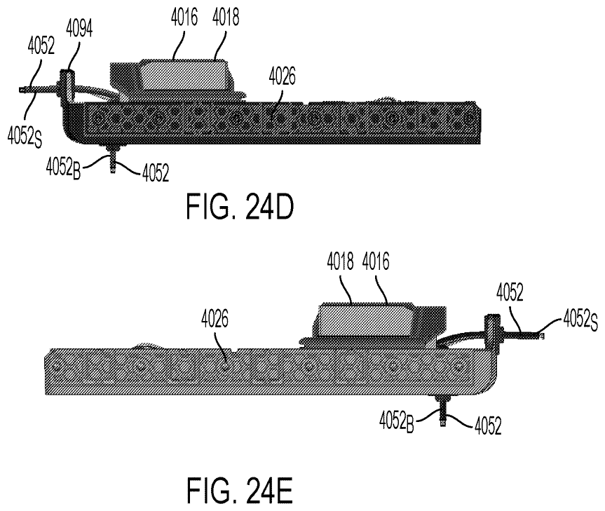

FIGS. 23A-23E show various views of the core block 4026 of the interface 4010. FIGS. 24A-24E show various views of the terminal block 4016 (along with the terminals 4018) placed on the core block 4026. The terminal block positioning assembly 4098 (including the bracket/support member 4100 that is fixedly attached to the core block 4026, and the spring 4102 that connects the terminal block 4016 to the bracket/support member 4100) may be used to position the terminal block 4016 with respect to the core block 4026.

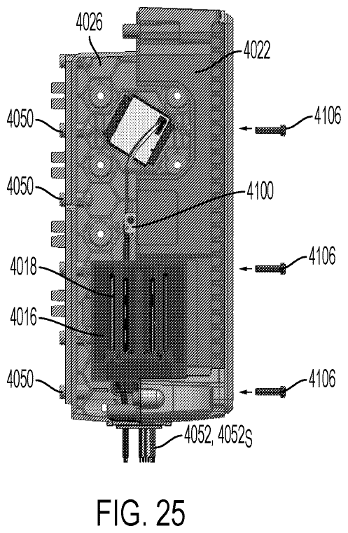

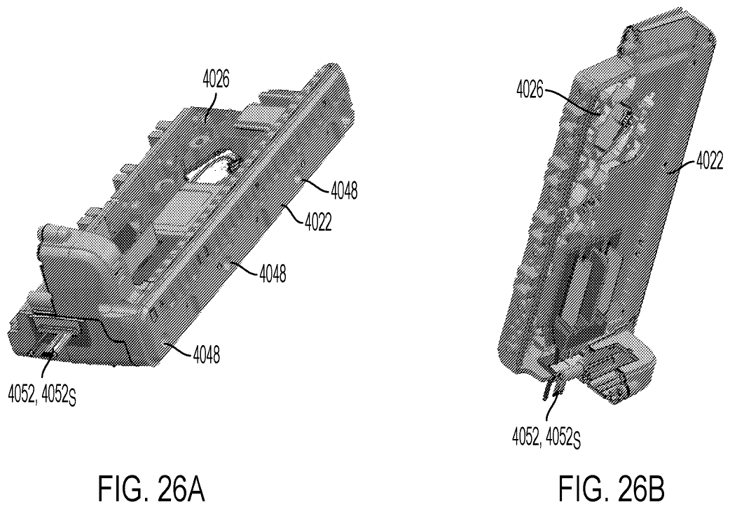

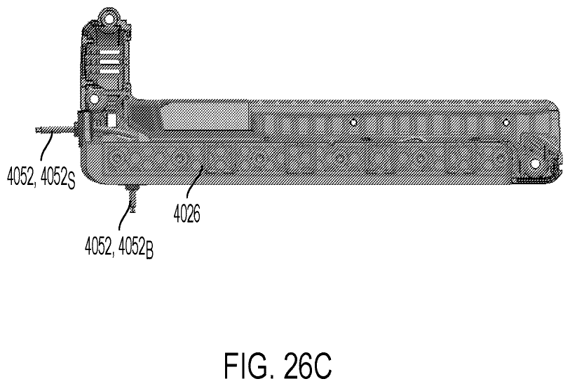

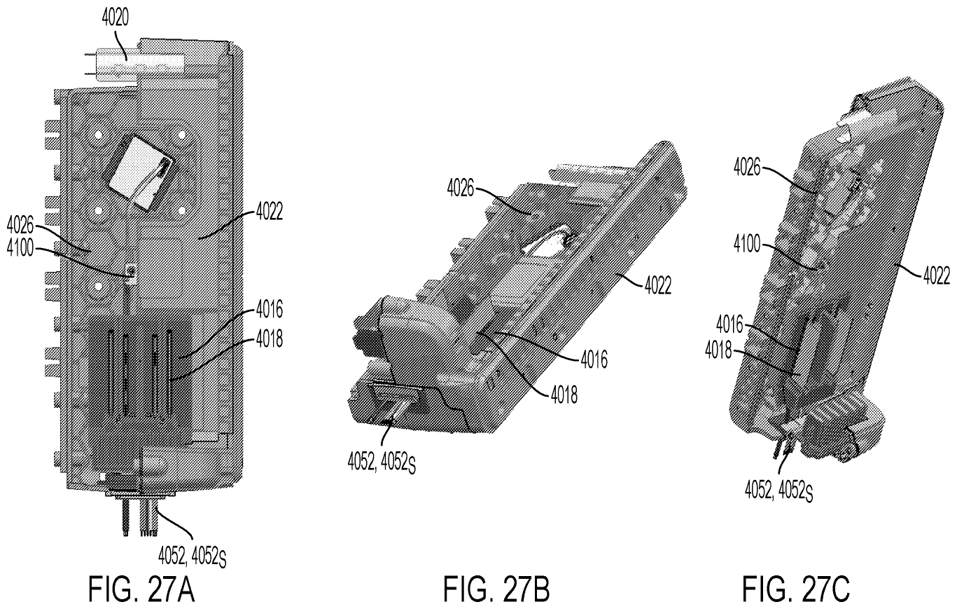

FIG. 25 shows one of the first and second housing members 4022, 4024 coupled to the core block 4026. FIGS. 26A-26C show various views of one of the first and second housing members 4022, 4024 fastened to the core block 4026. The second set of holes 4048 (as shown in FIG. 26A) of one of the first and second housing portions 4022, 4024 may be configured to align with the corresponding set of holes 4050 (as shown in FIG. 25) in the core block 4026 so as to connect the core block 4026 to one of the first and second housing portions 4022, 4024. Fasteners 4106 may be inserted through the second set of holes 4048 of one of the first and second housing portions 4022, 4024 and the corresponding set of holes 4050 in the core block 4026 after they are aligned, for connecting the core block 4026 to one of the first and second housing portions 4022, 4024. FIGS. 27A-27C show various views of the catch 4020 coupled to one of the first and second housing members 4022, 4024.

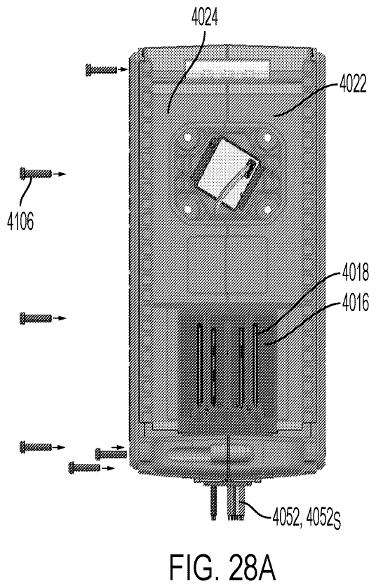

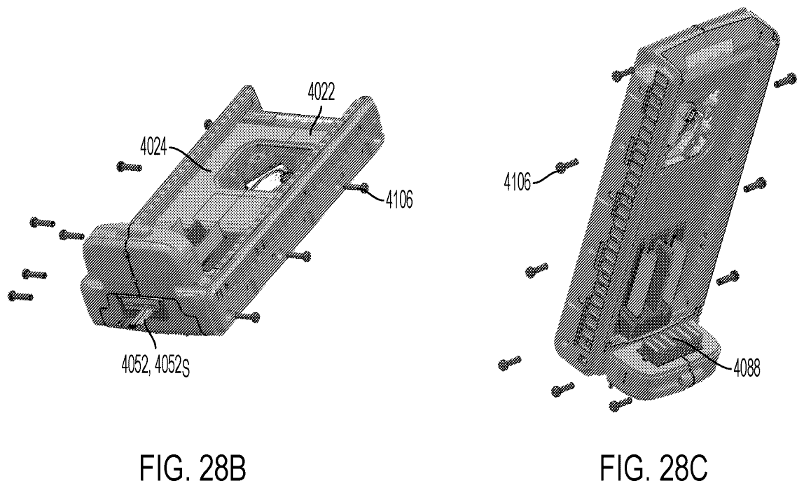

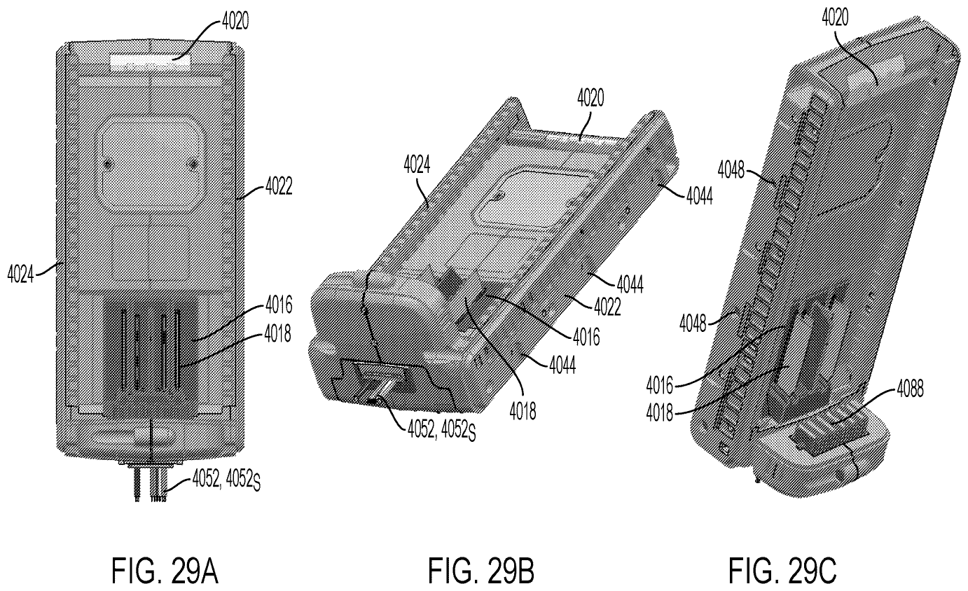

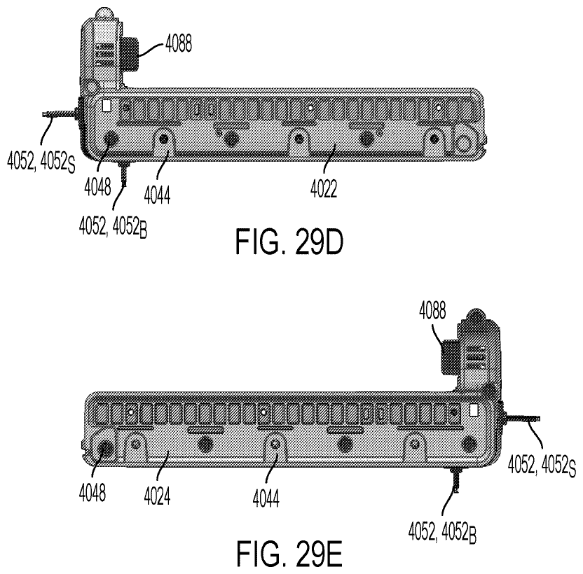

FIGS. 28A-28C show various views of the other of the first and second housing portions 4022, 4024 coupled to the core block 4026. The second set of holes 4048 of the other of the first and second housing portions 4022, 4024 may be configured to align with the corresponding set of holes 4050 in the core block 4026 so as to connect the core block 4026 to the other of the first and second housing portions 4022, 4024. Fasteners 4106 may be inserted through the second set of holes 4048 of the other of the first and second housing portions 4022, 4024 and the corresponding set of holes 4050 in the core block 4026 after they are aligned, for connecting the core block 4026 to the other of the first and second housing portions 4022, 4024. FIGS. 29A-29E show the other of the first and second housing portions 4022, 4024 fastened to the core block 4026.

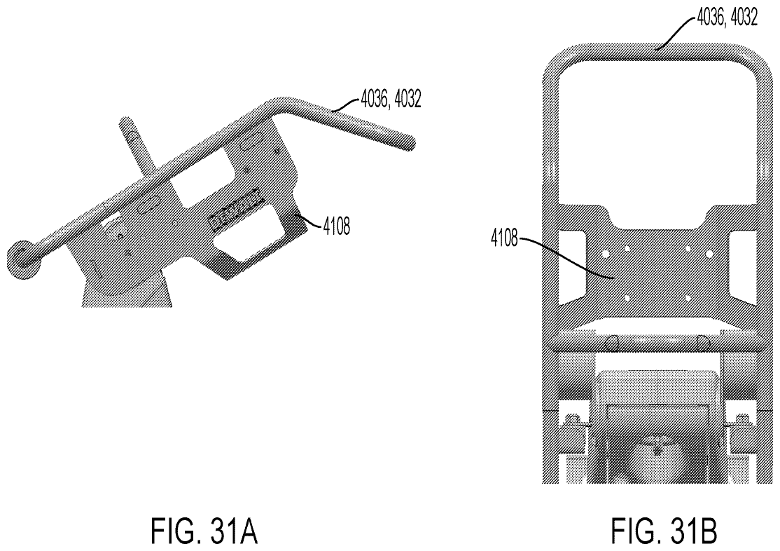

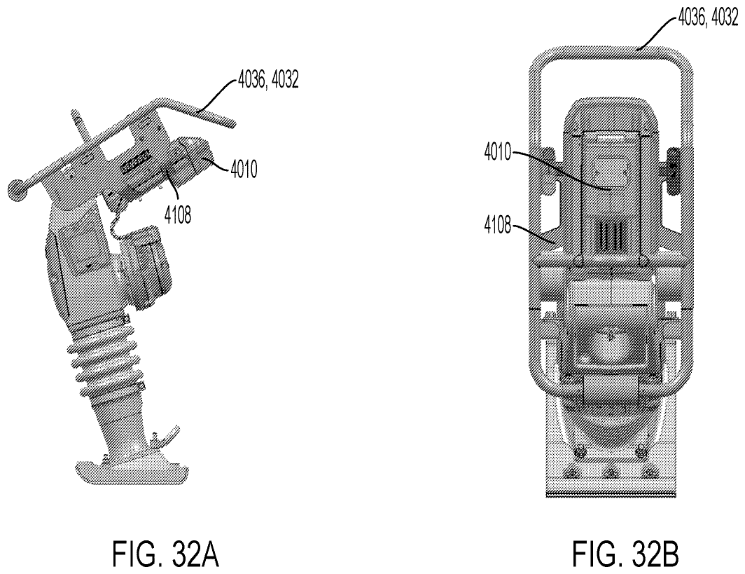

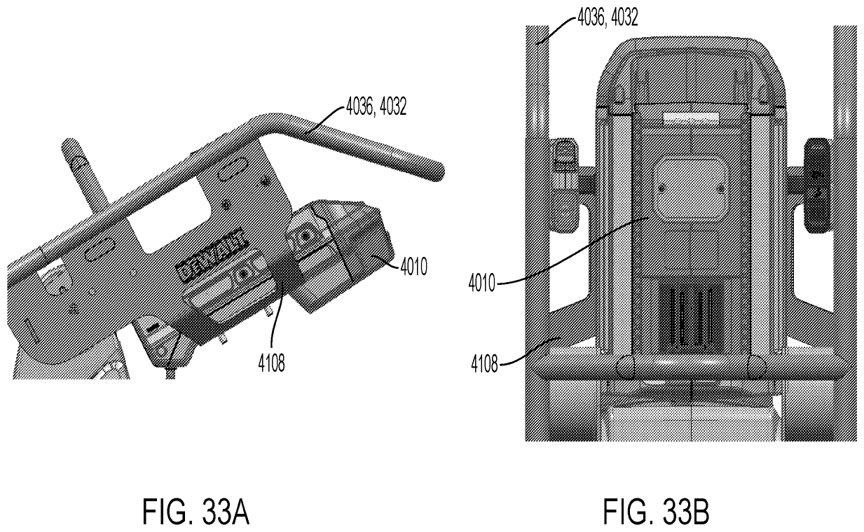

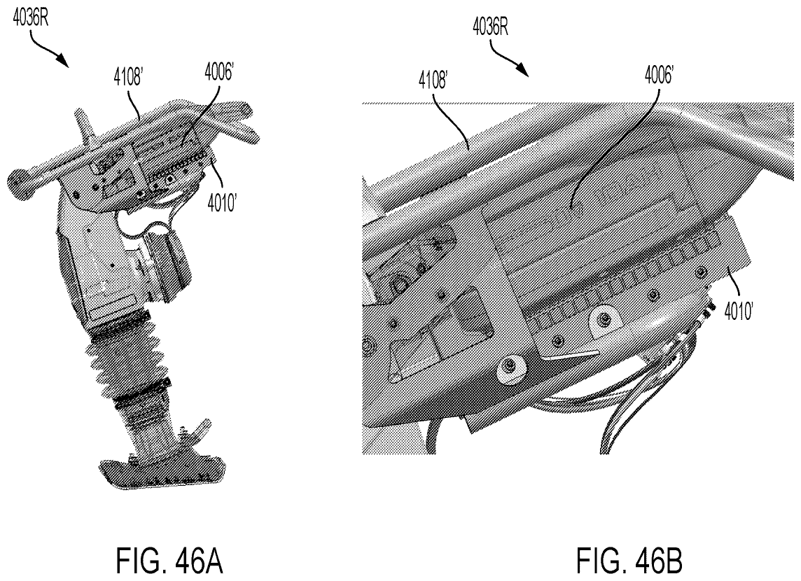

FIGS. 30A-30B and 31A-31B show various views (some detailed views) of the frame 4108 of the second cordless power tool 4036. FIGS. 32A-32B and 33A-33B show various views (some detailed views) of the interface 4010 fastened to the frame 4108 of the second cordless power tool 4036. FIGS. 34A-34B and 34A-34B show various views (some detailed views) of the battery pack 4006 coupled to the interface 4010 and the second cordless power tool 4036. FIGS. 46A-46B show various views (some detailed views) of an alternate example embodiment of the interface 4010 fastened to the frame 4108 of the second cordless power tool 4036, wherein the battery pack 4006 is coupled to the interface 4010.

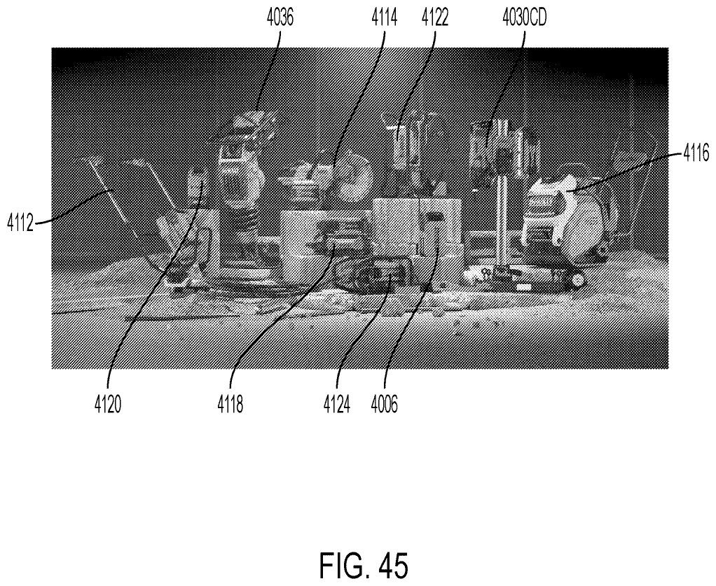

FIG. 45 shows an example power tool system 4032, including several example cordless power tools, battery packs 4006, charger 4118, and battery pack adaptor 4120, all incorporating the battery pack interface 4010 of the present patent application. The cordless power tools may include screed/concrete screed 4112, rammer 4036R, concrete vibrator power pack 4124, concrete vibrator backpack 4122, core drill stand 4030CD, plate compactor 4116, 12 inch cutoff saw 4114, etc.

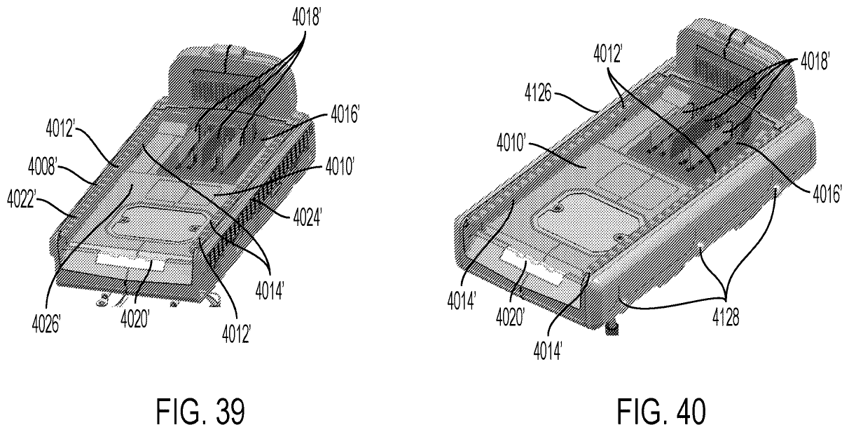

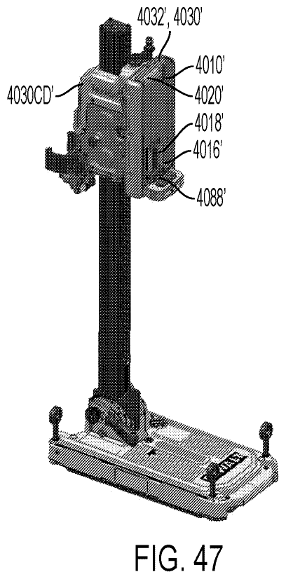

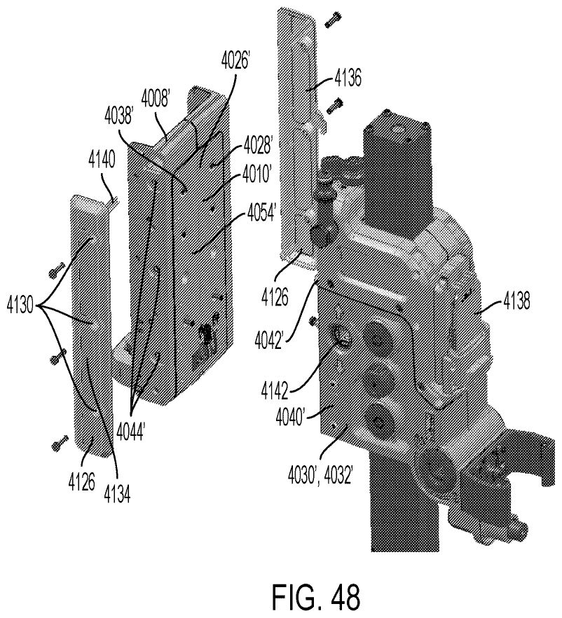

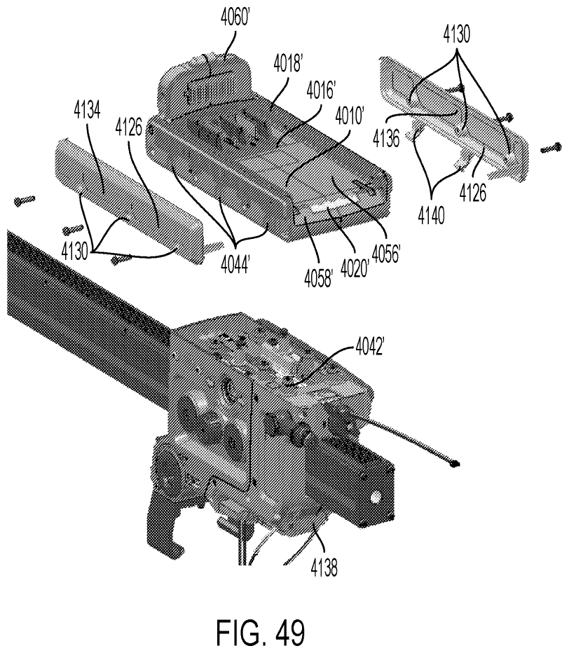

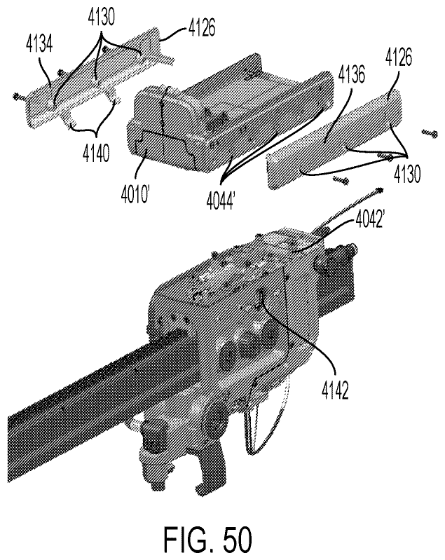

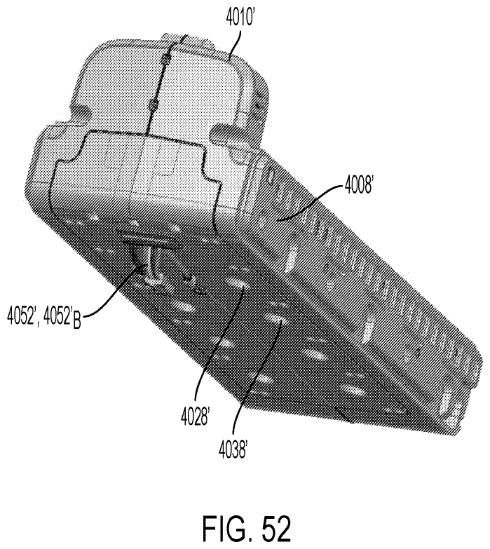

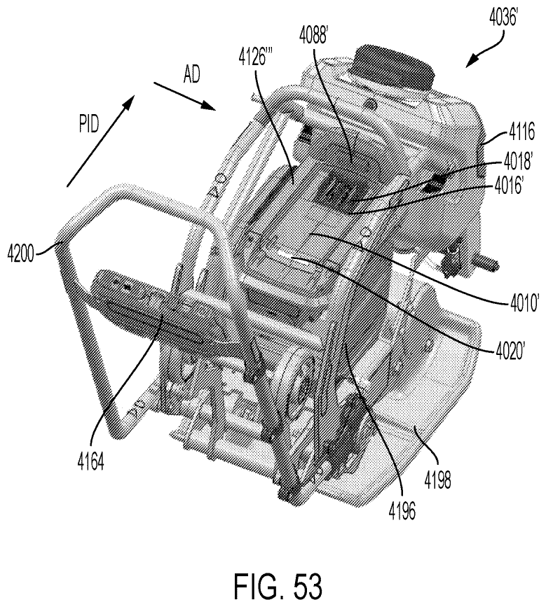

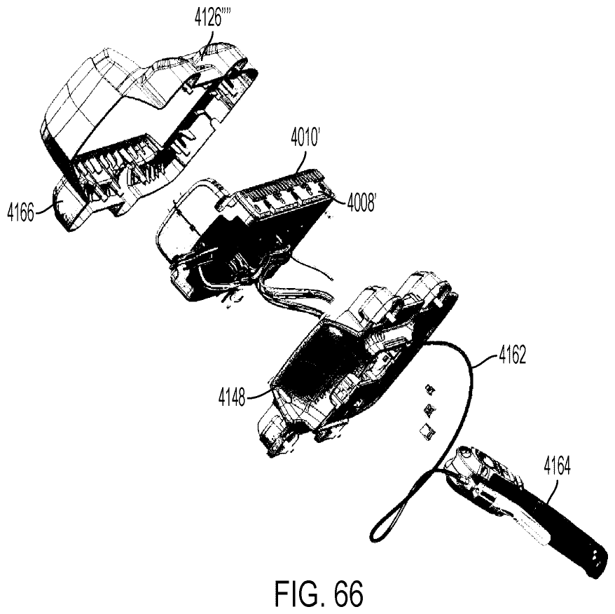

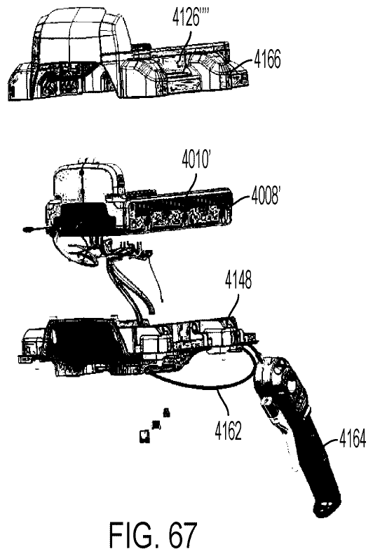

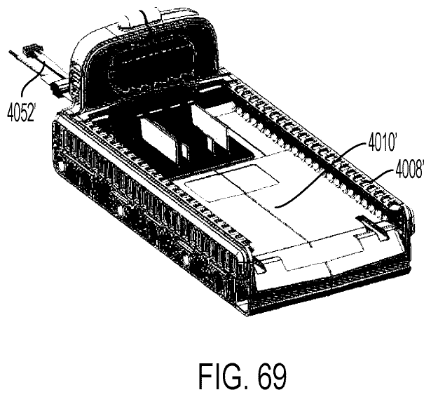

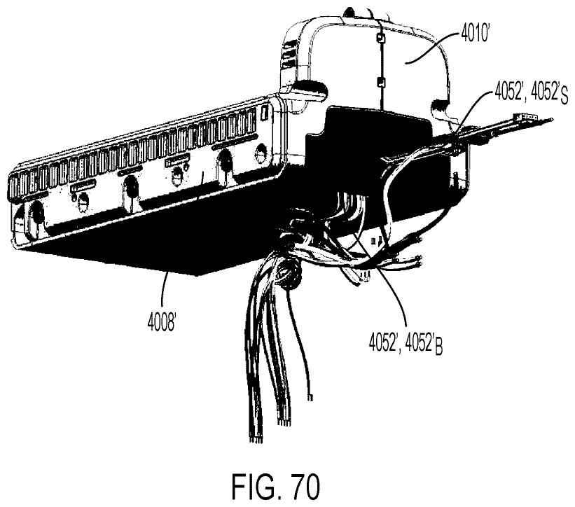

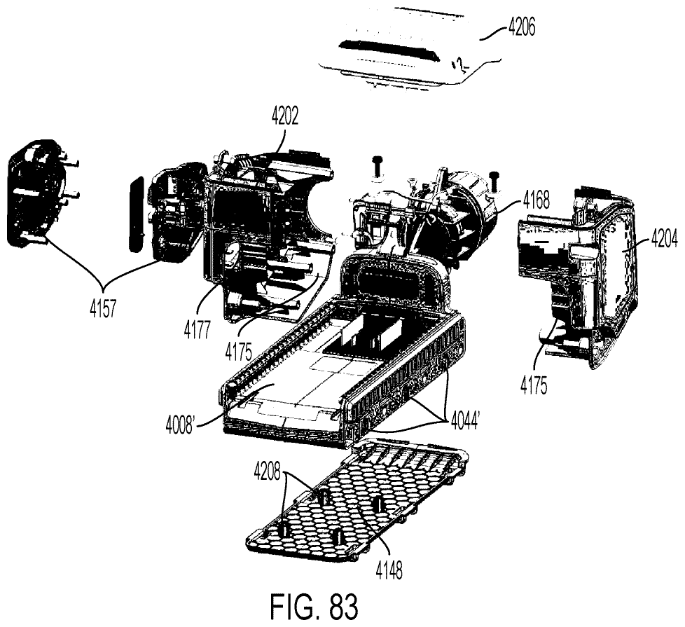

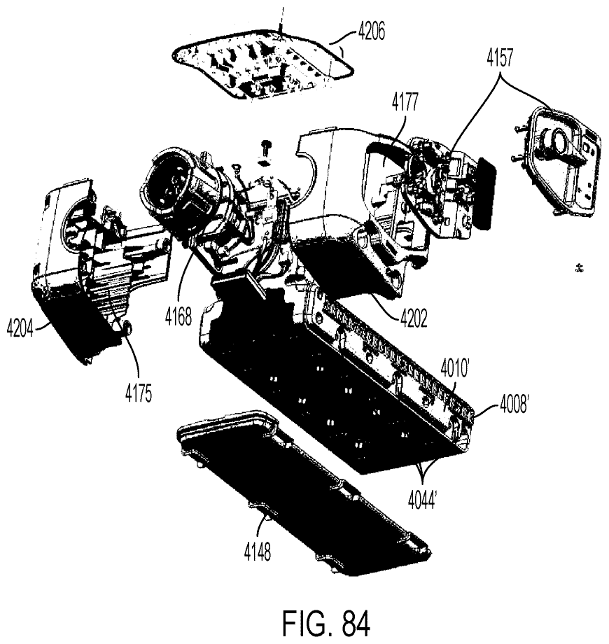

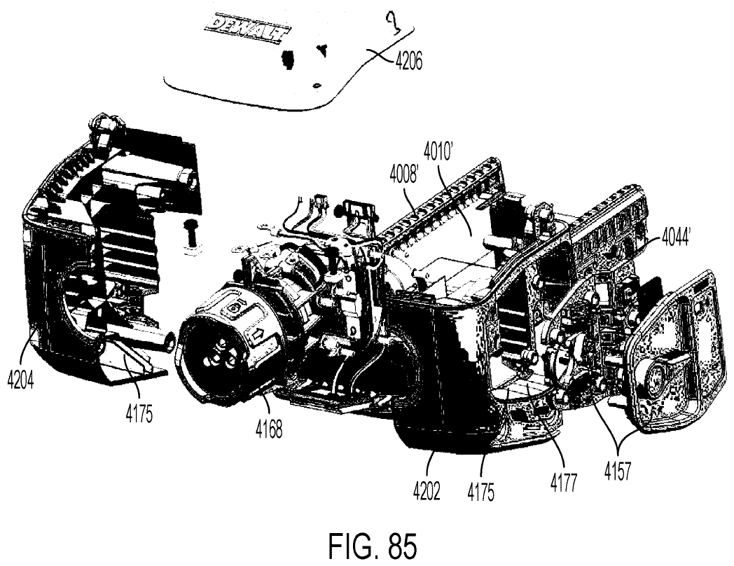

Referring to FIGS. 39-44B and 47-85, another embodiment of an interface system 4000′ for enabling mating and operation between a set of cordless power tools 4032′ and a battery pack is described. The interface system 4000′ may include a first housing 4008′ and a second housing 4126. The first housing 4008′ may include an interface 4010′ for mating with a battery pack 4006′. The interface 4010′ may include a set of rails 4012′, a set of grooves 4014′, a terminal block 4016′, and a catch 4020′. The terminal block 4016′ may include a set of terminals 4018′. The first housing 4008′ may include the first attachment feature 4028′ (not shown in FIGS. 39-43 but the first attachment feature 4028′ may have the same configuration/construction as the first attachment feature 4028) configured to attach the interface 4010′ to the first cordless power tool 4030′ of the set of cordless power tools 4032′ in a first orientation (as shown in FIGS. 47-52). The second housing 4126 may be attached to the first housing 4008′. The second housing 4126 may include a second attachment feature 4128 that may be configured to attach the interface 4010′ to the second cordless power tool 4036′ of the set of cordless power tools 4032′ in a second orientation (as shown in FIGS. 53-85). The second housing 4126 may be positioned between the first housing 4008′ and the second cordless power tool 4036′.

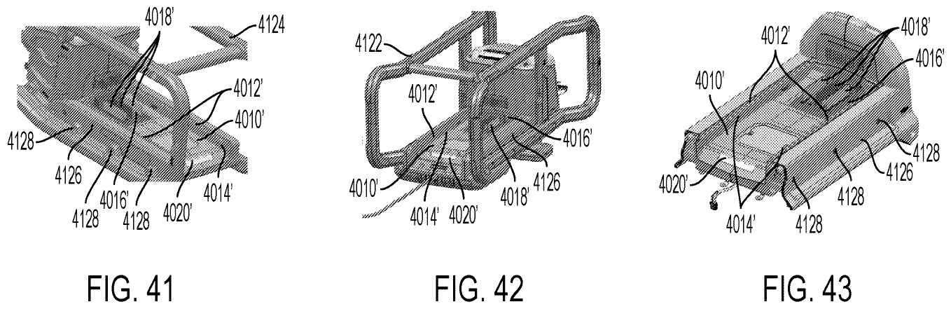

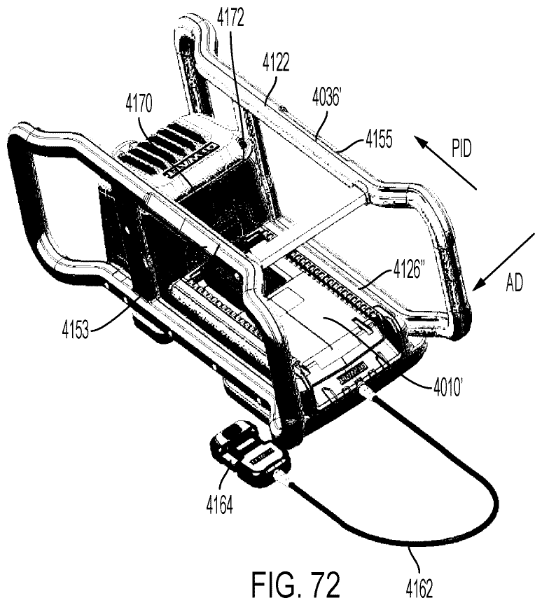

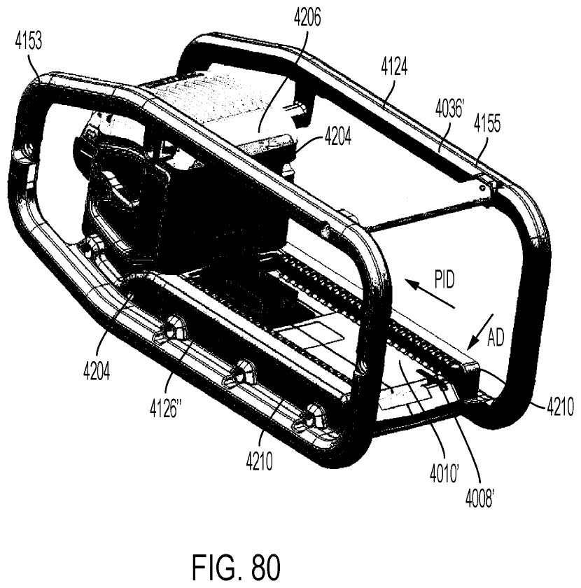

FIG. 39 shows the interface 4010′ without the second housing 4126. FIG. 40 shows a first example outer/second housing 4126 that is coupled to the interface 4010′. FIG. 41 shows the combination of a second example second housing 4126′ and interface 4010′ incorporated in a third example power tool (e.g., vibrator power pack 4124 that is also shown and described in detail in FIGS. 80-85). FIG. 42 shows the combination of a third example second housing 4126″ and the interface 4010′ incorporated in a fourth example power tool (e.g., concrete vibrator backpack 4122 that is also shown and described in detail in FIGS. 72-79). FIG. 43 shows a fourth example second example second housing 4126′″ coupled to the interface 4010′.

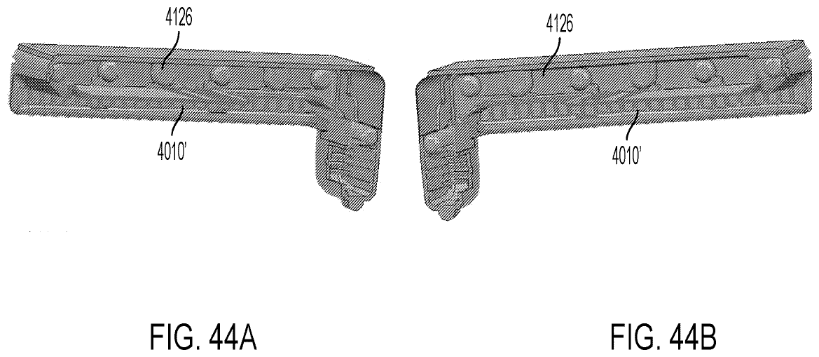

While FIGS. 39-43 show a method of coupling the second housing 4126 (e.g., clamshells) to the interface 4010′, for example, using a set of fasteners, FIGS. 44A-44B show a method of coupling the second housing 4126 (with first and second clamshell portions) to the interface 4010′, for example, using a molded connection (i.e., a connection in mold from tool).

As shown in FIG. 39, the first housing 4008′ comprises a first housing portion 4022′, a second housing portion 4024′, and a core block 4026′ that is positioned between and coupled to the first and second housing portions 4022′ 4024′. The core block 4026′ including the first attachment feature 4028′. The first attachment feature 4028′ includes a set of holes 4038′ in the core block 4026′ configured to mate with a corresponding fixture 4040′ on the first cordless power tool 4030′. The first housing 4008′ may comprise two housing portions forming an internal cavity and the core block 4026′ may be positioned in the internal cavity. The first attachment feature 4028′, the core block 4026′, the internal cavity of the first housing 4008′ and the set of holes 4038′ in the core block 4026′ are not shown in FIGS. 39-43 but they may have the same configuration/construction as the first attachment feature 4028, the core block 4026, the internal cavity 4025 of the first housing 4008 and the set of holes 4038 in the core block 4026.

A terminal block 4016′ including the set of terminals 4018′ is coupled to or disposed on the core block 4026′. The core block 4026′ may also include the wire harness 4052′ that is configured to be electrically coupled to either the first cordless power tool 4030′ or the second cordless power tool 4036′. The core block 4026′ may include a tool interface side 4054′ that is opposing a battery pack interface side 4056′. The wire harness 4052′ is configured to extend from the tool interface side 4054′. The interface 4010′ may include a front portion 4058′ and a rear portion 4060′. The catch 4020′ is disposed in the front portion 4058′ of the interface 4010′. Other details of the core block, the first housing (including the first and second housing portions), the first attachment feature (including the set of holes), the fixture, the first cordless power tool, etc. are all described in detail with respect to the first embodiment shown and described with respect to FIGS. 3-38, and 45-46B and, therefore, will not be described in detail again here. The battery pack 4006′ that is configured to be used with the interface 4010′ is described in detail with respect to the above disclosed embodiment of the interface shown and described with respect to FIGS. 3-38, and 45-46B and, therefore, will not be described in detail again here.

The second attachment feature 4128 of the second housing 4126 may include a set of holes 4130 in the second housing 4126 configured to mate with a corresponding fixture 4132 on the second cordless power tool 4036′. As explained in detail with respect to FIGS. 53-85, portions of the second housing 4126 that are positioned between the first housing 4008′/the interface 4010′ and the second cordless power tool 4036′ are first housing portions of the second housing 4126. The second housing 4126 may include second housing portions that are positioned on the sides and/or ends surrounding the first housing and the interface 4010′.

FIGS. 47-50 show the first cordless power tool 4030′ with the interface 4010′ coupled thereto. The first cordless power tool 4030′ is a core/concrete drill system 4030CD′. The core/concrete drill 4030CD′ has been described in detail above. The second housing 4126 may include second housing side portions 4134, 4136. The second housing side portions 4134, 4136 may include engagement portions 4140 that are configured to engage with portions of the first housing 4008′ so as to couple the second housing 4126 to the interface 4010′ (and the first housing 4008′). The second housing 4126 and the interface 4010′ (and the first housing 4008′) may also be coupled to each other using fasteners passing through aligned holes 4130 (in the second housing 4126) and openings 4044′ (in the first housing 4008′).

A stand engaging portion 4142 may be configured to removably engage with a portion of the concrete drill stand to enable movement of the drill up and down. The stand engaging portion 4142 may include a gear 4142 that is configured to move the stand up and down.

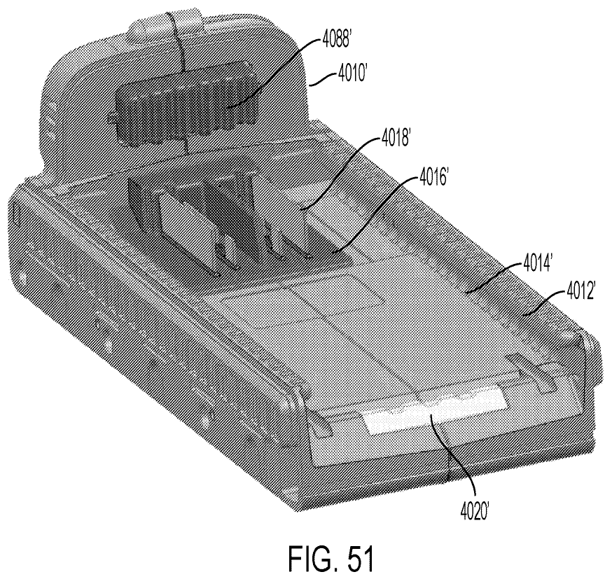

FIGS. 51-53 show the interface 4010′. The interface 4010′ (including the terminal block 4016′, the terminals 4018′, the wire harness 4052′, etc.) and the first housing 4008′ are generally the same as the interface 4010 and the housing 4008 and will not be described in detail.

The fixture 4040′ on the core/concrete drill stand may include protrusions 4042′ that are configured to align with and to be received in the set of holes 4038′ (of the first attachment feature 4028′) in the core block 4026′ so as to attach the interface 4010′ to the concrete drill stand in the first orientation. In the first orientation, the interface 4010′ is positioned in a generally vertical orientation. The generally vertical orientation may be parallel to a vertical axis.

The procedures in which the interface 4010′ and the second housing 4126 may be attached to the core/concrete drill stand are explained below. In these procedures, a tool engaging housing portion 4138 may be part of the fixture 4040′ of the concrete drill stand. The tool engaging portion 4138 may be part of the drill stand and may be a tool (drill) terminal housing. The tool (drill) with its foot may be connected to the tool engaging portion 4138. The stand may include an internal wiring harness/circuit inside that is configured to connect the battery pack 4006 to the tool.

The core block 4026′ is attached/connected to the fixture 4040′ of the concrete drill 4030CD′. The second housing side portions 4134, 4136 of the second housing 4126 are then connected to the interface 4010′ (and the first housing 4008′) while the interface 4010′ is connected to the fixture 4040′ of the concrete drill stand.

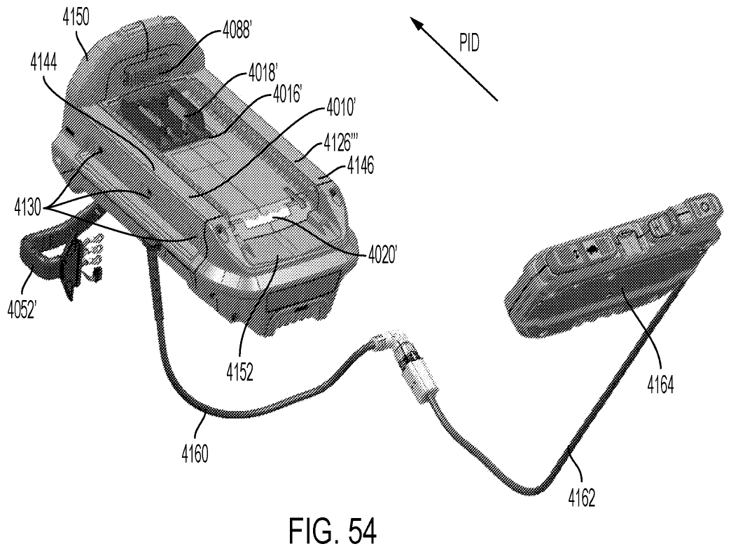

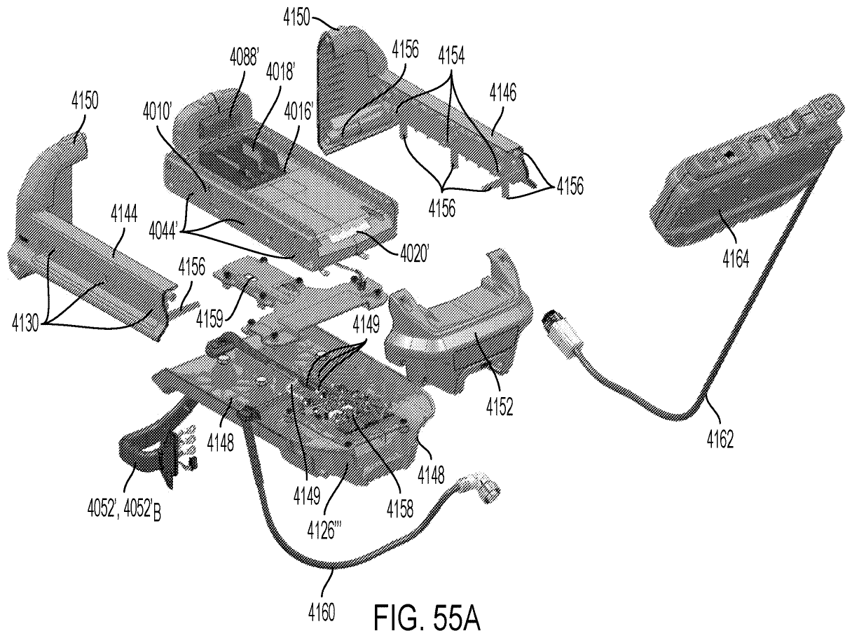

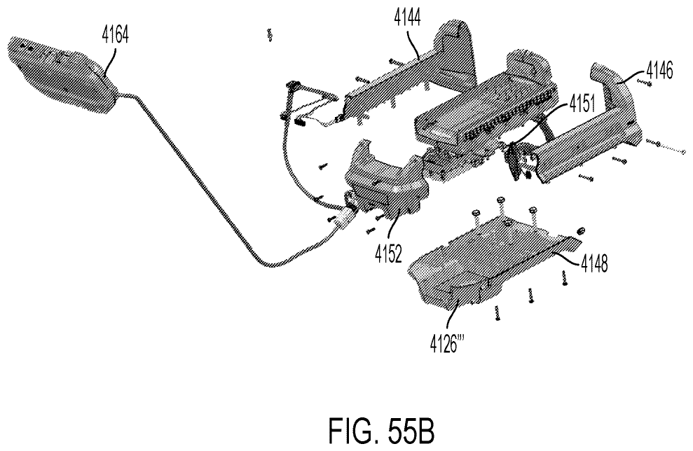

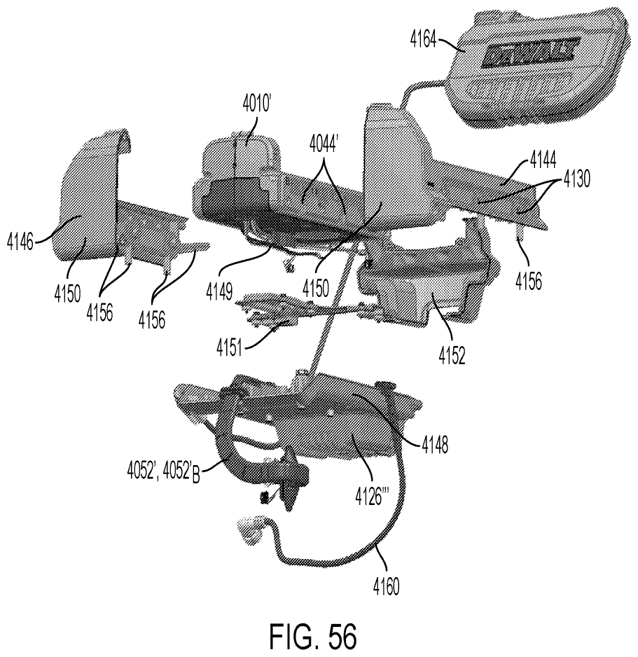

FIG. 53 shows a perspective view of the second cordless power tool 4036′ (with the interface 4010′ mounted thereon). FIG. 54 shows an assembled view of portions of the plate compactor 4116, the interface 4010′, and portions of the second façade/outer housing 4126′″. FIGS. 55A-56 show exploded views of the portions of the compactor or plate compactor 4116, the interface 4010′, and portions of the second façade/outer housing 4126′″. The second cordless power tool 4036′ may be a compactor or plate compactor 4116, as illustrated in FIGS. 53-56.

The compactor 4116 may include a main body 4196 and a vibrating plate portion 4198. The plate portion 4198 may be adapted for compacting soil, gravel, sand, silt or any other material to be compacted. The compactor 4116 also may include a handle 4200 by which a user can maneuver the compactor 4116, a motor, and a battery pack (e.g., the battery pack 4006) for powering the motor of the compactor 4116. The compactor 4116 may include a user operable switch (may also be referred to as a “trigger” or “power switch”) and a control module (may also be referred to as “electronic control module”, or “motor control module”). The motor control module may include a controller and electronic switching components for regulating the supply of power from the battery pack 4006 to the motor. The motor control module may be disposed within the housing of the main body of the compactor 4116 or at any location within or on the compactor 4116. The motor control module may also integrally include components to support a user operated input unit or user interface 4164 (may be referred to as “input unit” or “control unit”) for receiving user function selections, such as an ON/OFF signal, variable-speed signal, and forward-reverse signal. LEDs may be integrated in the user interface 4164. The LEDs may be configured to provide feedback, such as variable speed, service/maintenance, errors, other information etc. to the user. The handle 4200 of the compactor 4116 may be detachable by the user.

Referring to FIGS. 55A-56, a plurality of wires 4149 may be configured to be received in a second housing bottom portion 4148. The second housing bottom portion 4148 may be part of the second façade/outer housing 4126′″. A wire cover 4151 may be configured to cover the wires 4149 received in the second housing bottom portion 4148. The wire cover 4151 may be configured to be mounted on the second housing bottom portion 4148.

The second housing 4126′″ may include second housing side portions 4144, 4146, second housing end portions 4150, 4152 and the second housing bottom portion 4148. The second housing end portion 4150 may be integrally formed with respective second housing side portions 4144, 4146. The second housing side portions 4144, 4146 may include engagement portions 4154 that are configured to engage with portions of the first housing 4008′ so as to couple the second housing 4126′″ to the interface 4010′ (and the first housing 4008′). The second housing 4126′″ may also include engagement portions 4156 that are configured to engage with other portions of the second housing 4126′″ so as to couple the second housing side portions 4144, 4146, second housing end portions 4150, 4152 and the second housing bottom portion 4148 of the second housing 4126′″ to each other. The second housing 4126′″ and the interface 4010′ (and the first housing 4008′) may also be connected to each other using fasteners passing through aligned holes 4130 (in the second housing 4126′″) and openings 4044′ (in the first housing 4008′).

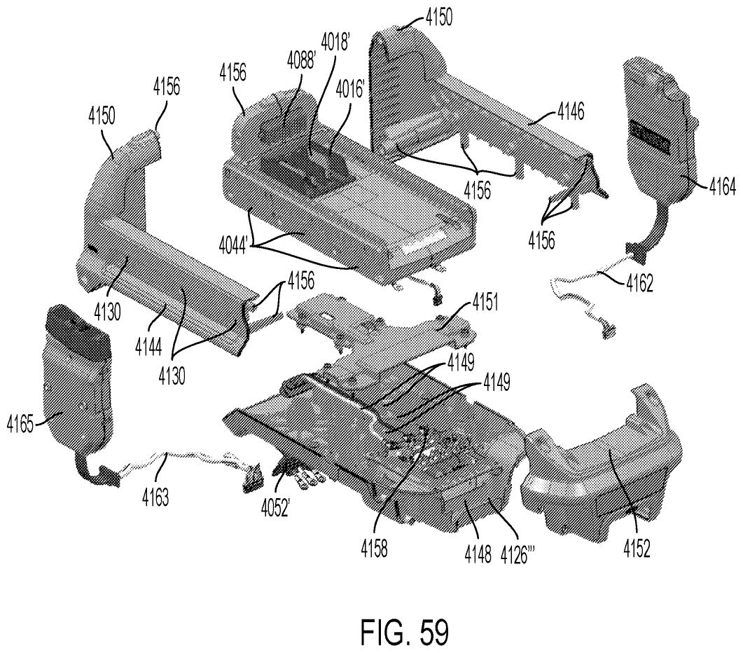

The second housing 4126′″ may be configured to receive an electronics module 4158 in the second housing bottom portion 4148. The electronics module 4158 may include a wire harness 4160 that is configured to be coupled with a wire harness 4162 of the user interface 4164 of the second cordless power tool 4036′. Referring to FIG. 59, the plurality of wires 4149 may be configured to be received in the second housing bottom portion 4148. The second housing bottom portion 4148 may be part of the second façade/outer housing 4126′″. A wire cover 4151 may be configured to cover the wires 4149 received in the second housing bottom portion 4148. The wire cover 4151 may be configured to mounted on the second housing bottom portion 4148. The cover 4151 may also be configured to cover the wire harness 4160 and portions of the electronics module 4158.

The procedures in which the interface 4010′ and the second housing 4126′″ may be attached to the plate compactor 4116 are explained below. In these procedures, the interface 4010′ and the second housing 4126′″ are first connected to each other. The second housing 4126′″ (with the interface 4010′) is connected to the plate compactor 4116.

The second attachment feature 4128 (and the openings 4130) of the second housing 4126′″ may be configured to attach the interface 4010′ to the compactor 4116 in a second orientation (as shown in FIG. 53). The second housing bottom portion 4148 of the second housing 4126′″ may be positioned between (a) a combination of the first housing 4008′ and the interface 4010′ and (b) the compactor 4116. In the second orientation, the interface 4010′ may be positioned in a generally angled orientation with respect to the horizontal axis and the vertical axis. In the second orientation, the interface 4010′ may be in a generally horizontal orientation. Referring to FIG. 53, the direction of attachment AD of the interface 4010′ to the plate compactor 4116 may be perpendicular to a direction of insertion PID of the battery pack 4006 on to the interface 4010′.

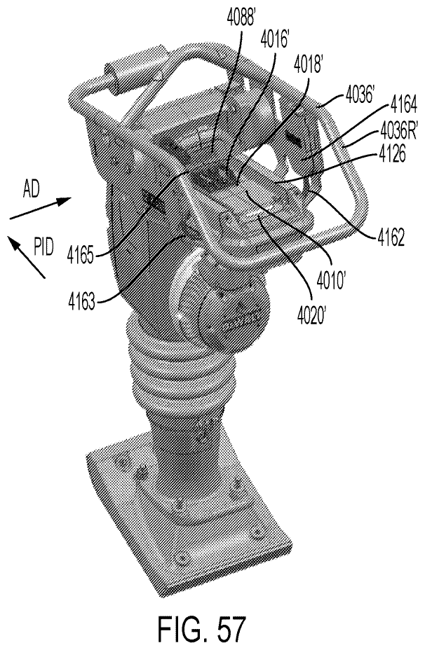

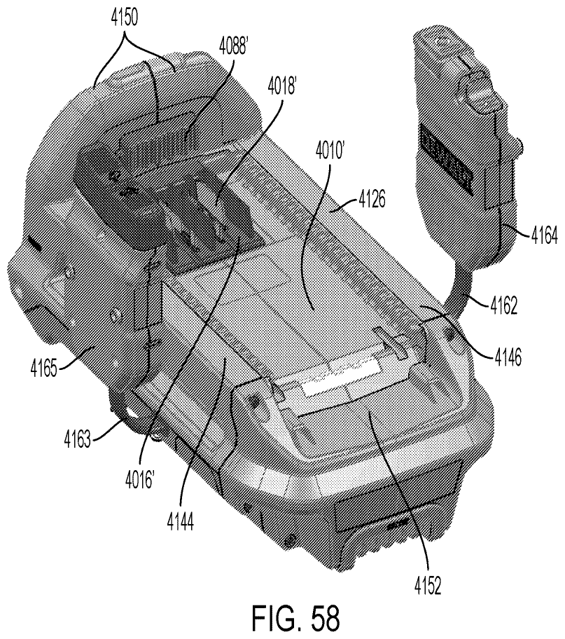

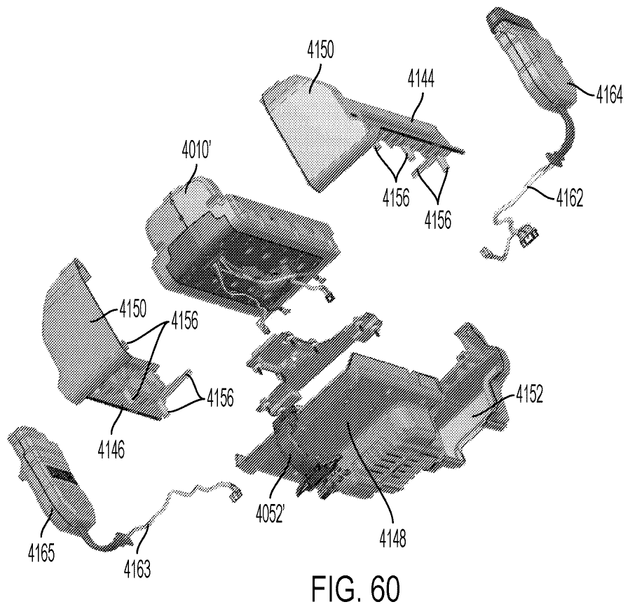

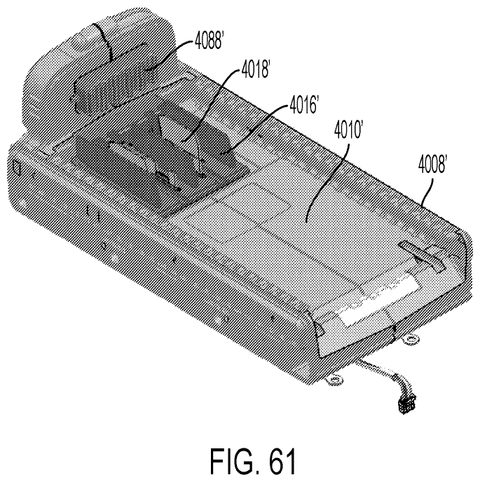

FIG. 57 shows a perspective view of the second cordless power tool 4036′ with the interface 4010′ mounted thereon. FIG. 58 shows an assembled view of the portions of the second cordless power tool 4036′, the interface 4010′, and portions of the façade/outer housing 4126′″. FIGS. 59-60 show exploded views of the portions of the second cordless power tool 4036′, the interface 4010′, and portions of the façade/outer housing 4126′″. FIG. 61 shows show a perspective view of the interface 4010′. The rammer 4036R′ has been described in detail above. The second cordless power tool 4036′ may be a rammer 4036R′, as illustrated in FIGS. 57-60.

The second housing 4126′″ of the rammer 4036R′ is very similar to the second housing 4126′″ of the plate compactor 4116 (in FIGS. 53-56), except for the differences noted below. The rammer 4036R′ may include two user interfaces 4164, 4165 that are connected to the interface 4010′ via two wire harnesses 4162, 4163. The procedures in which the interface 4010′ and the second housing 4126′″ may be attached to the rammer 4036R′ are also similar to those explained above with respect to the plate compactor 4116. The user interface 4164, 4165 may also be referred to as control units.

The second attachment feature 4128 (and the openings 4130) of the second housing 4126′″ may be configured to attach the interface 4010′ to the rammer 4036R′ in the second orientation (as shown in FIG. 57). The second housing bottom portion 4148 of the second housing 4126′″ may be positioned between (a) a combination of the first housing 4008′ and the interface 4010′ and (b) the rammer 4036R′. In the second orientation, the interface 4010′ may be positioned in a generally angled orientation with respect to the horizontal axis and the vertical axis. Alternatively, in the second orientation, the interface 4010′ may be in a generally horizontal orientation. The direction of attachment AD of the interface 4010′ to the rammer 4036R′ may be perpendicular to a direction of insertion PID of the battery pack 4006 on to the interface 4010′.

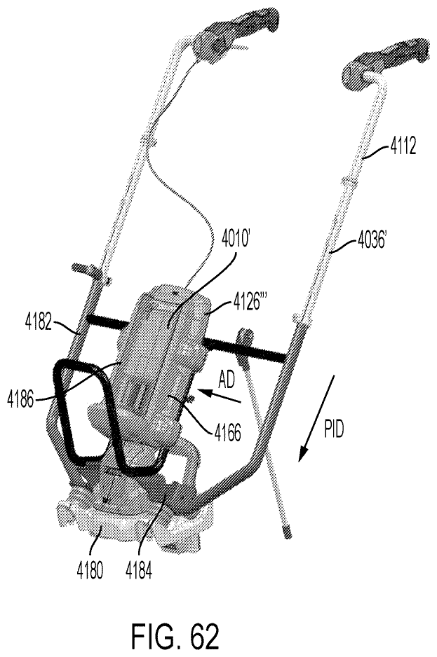

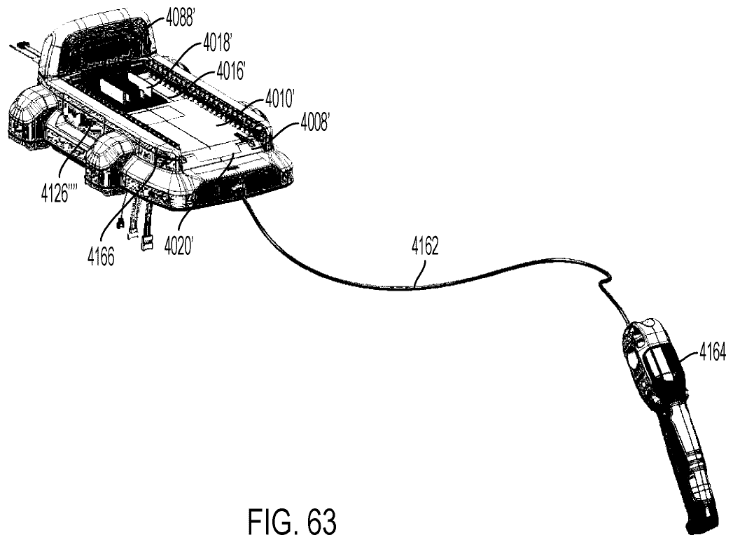

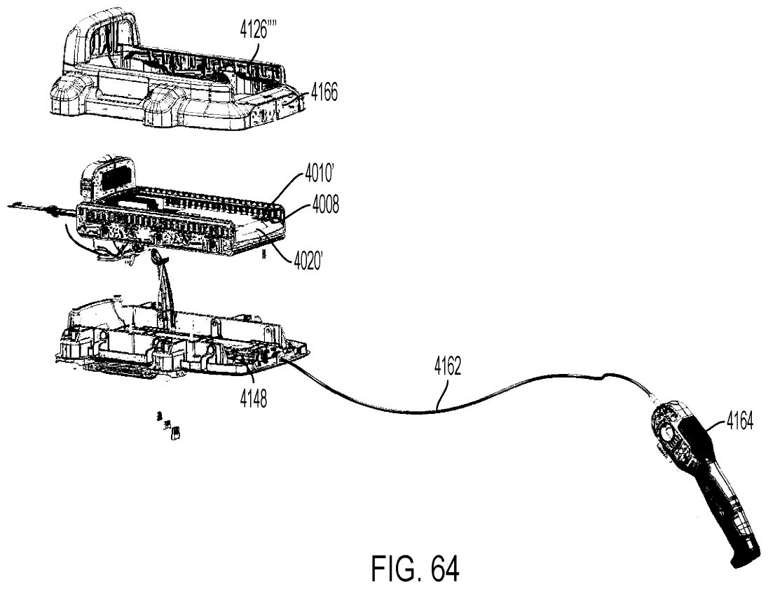

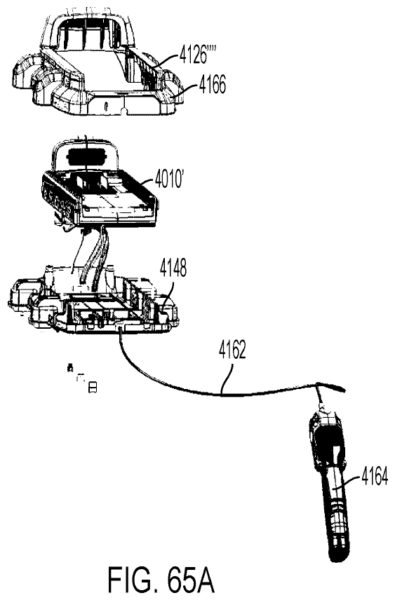

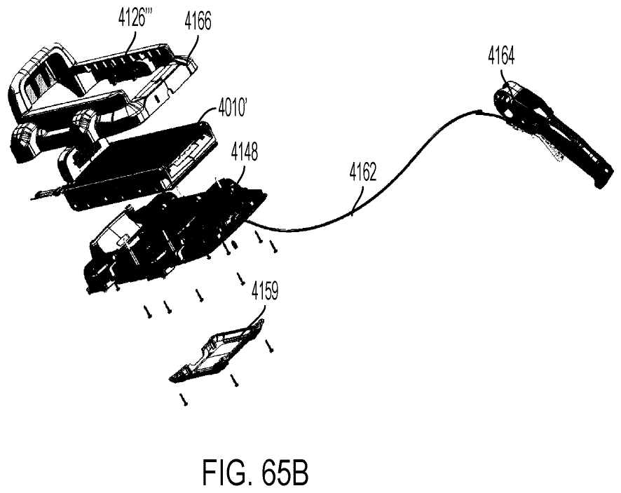

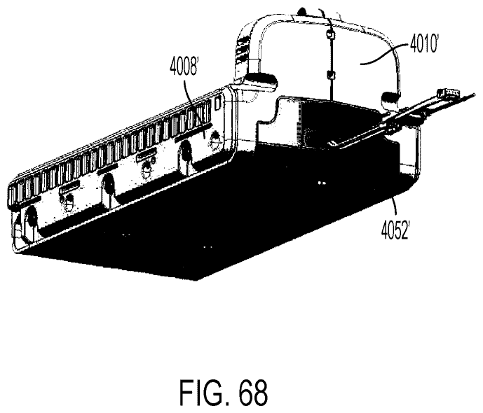

FIG. 62 shows a perspective view of the second cordless power tool 4036′ with the interface 4010′ mounted thereon. FIG. 63 shows an assembled view of portions of the second cordless power tool 4036′, the interface 4010′, and portions of the façade/outer housing 4126″″. FIGS. 64-67 show exploded views of portions of the second cordless power tool 4036′/4112, the interface 4010′, and portions of the façade/outer housing 4126″″. FIGS. 68-71 show various views of the interface 4010′. The second cordless power tool 4036′ may be a screed 4112, as illustrated in FIGS. 62-67. As shown in FIG. 65B, a housing portion 4159 may be mounted to the façade/outer housing 4126″″.

The screed (or vibrating screed tool) 4112 may be configured for leveling and smoothing a working material (e.g., wet concrete). The screed 4112 can include a base 4180, a frame assembly 4182 mounted to the base 4180 via a vibration dampening mechanism 4184, and a housing 4186 disposed on the frame assembly 4182 and supporting the removable power source (e.g., battery pack) 4006. The housing 4186 may house a motor (not shown) operatively coupled to the base 4180 and an eccentric vibration mechanism (not shown) coupled to the motor. The screed 4112 may include a beam (not shown) removably connected to the base 4180 and the motor and be configured to be vibrated by the eccentric vibration mechanism 4184 to provide a beam acceleration.

The second housing 4126″″ may include a top housing portion 4166 and the bottom housing portion 4148. The top housing portion 4166 and the bottom housing portion 4148 may have inter-engaging portions to connect them together. When the top housing portion 4166 and the bottom housing portion 4148 are connected together, the interface 4010′ (and the first housing 4008′) are received between them. The top housing portion 4166 may be configured to surround the sides and the edges of the interface 4010′ (and the first housing 4008′). The second housing 4126″″ may be configured to be coupled with the wire harness 4162 of the user interface 4164 of the screed 4112.

The procedures in which the interface 4010′ and the second housing 4126″″ may be attached to the screed 4112 are explained below. In these procedures, the interface 4010′ and the second housing 4126″″ are first connected to each other. The second housing 4126″″ (with the interface 4010′) is connected to the screed 4112.

The second attachment feature (and the openings) of the second housing 4126″″ may be configured to attach the interface 4010′ to the screed 4112 in a second orientation (as shown in FIG. 62). The openings and the second attachment feature may be configured to extend through the bottom housing portion 4148 of the second housing 4126″″. The bottom housing portion 4148 of the second housing 4126″″ may be positioned between (a) a combination of the first housing 4008′ and the interface 4010′ and (b) the screed 4112. In the second orientation, the interface 4010′ may be positioned in a generally angled orientation with respect to the horizontal axis and the vertical axis. In the second orientation, the interface 4010′ may be in a generally horizontal orientation. The direction of attachment AD of the interface 4010′ to the screed 4112 may be perpendicular to the direction of insertion PID of the battery pack 4006 on to the interface 4010′.

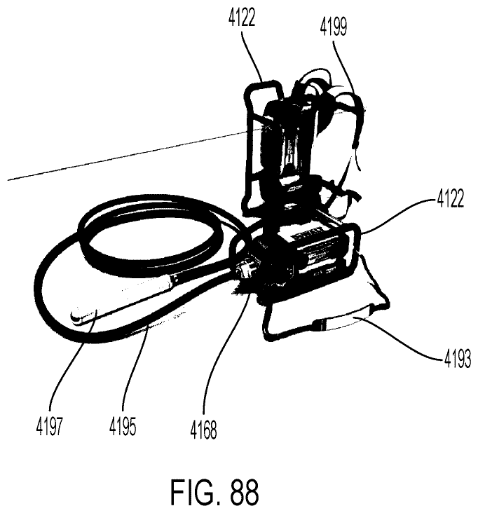

A concrete vibrator system may include a vibrating head 4197 including a head housing and a rotating shaft received in the housing. The shaft may include an eccentric portion that has an eccentric axis that is parallel to and offset from the shaft axis. The concrete vibrator system may also include a motor configured to drive the rotating shaft so that a vibrating head 4197 vibrates. The concrete vibrator system may include a power unit and a control module. The power unit may include a power unit housing having the battery receptacle/interface 4010′ and the battery pack 4006′ configured to be received in the battery receptacle/interface 4010′. The control module may be configured to control power delivery from the battery pack 4006′ to the motor. The concrete vibrator system may include a hose 4195 configured to couple the power unit to the vibrating head 4197. The motor may be received in the head housing and the hose 4195 may be configured to electrically couple the power unit to the motor. The motor may be received in the power unit housing and the hose may comprise a flexible shaft configured to couple the motor to the rotating shaft in the head. The hose 4195 and the vibrating head 4197 are shown in FIG. 88.

The concrete vibrator system may further comprise a backpack configured to carry a power delivery module. The concrete vibrator system with the backpack may be referred to as concrete vibrator backpack and it is as shown in and described in detail with respect to FIGS. I70-75.

The concrete vibrator system may further comprise a floor mountable frame configured to be coupled to the power delivery module. The concrete vibrator system with the floor mountable frame may be referred to as concrete vibrator power pack and is as shown in and described in detail with respect to FIGS. 80-85.

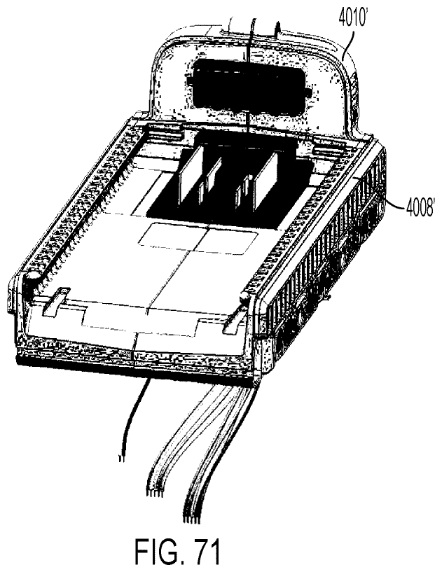

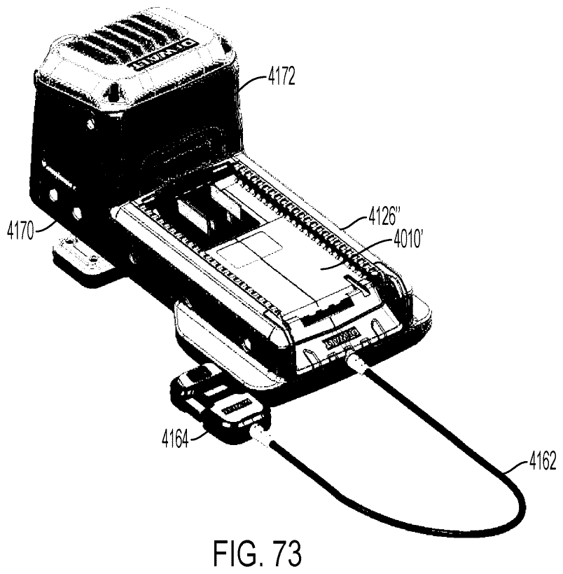

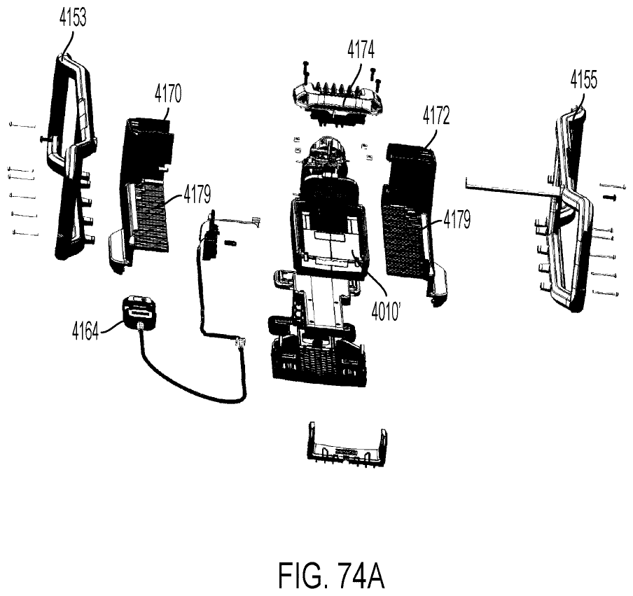

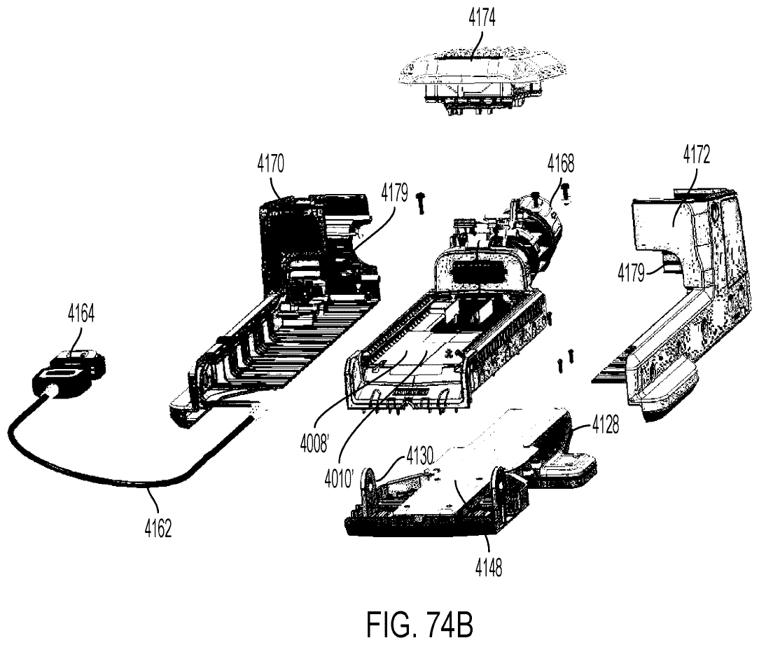

FIG. 71 shows a perspective view of the second cordless power tool 4036′ with the interface 4010′ mounted thereon. FIG. 73 shows an assembled view of the portions of the second cordless power tool 4036′, the interface 4010′, and portions of the façade/outer housing 4126″. Referring to FIGS. 71 and 74A, the façade/outer housing 4126″ may also include façade/protection cage portions 4153 and 4155.

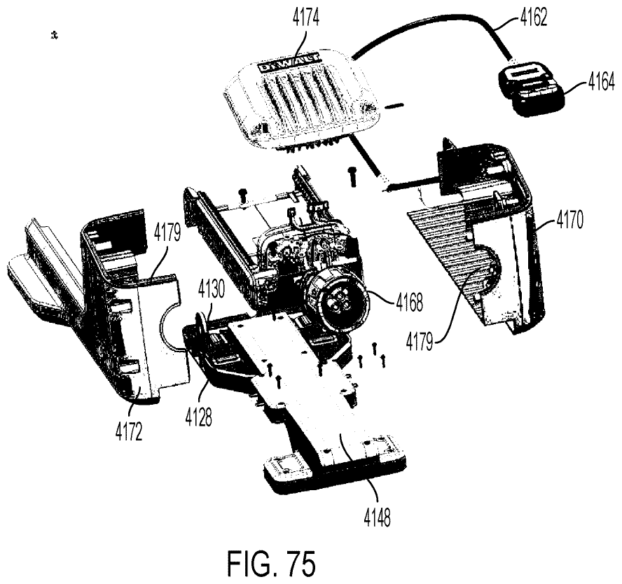

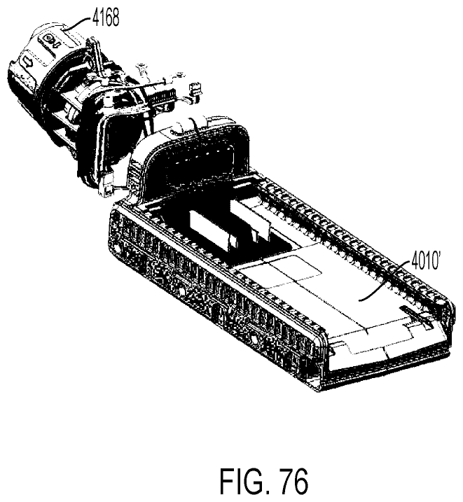

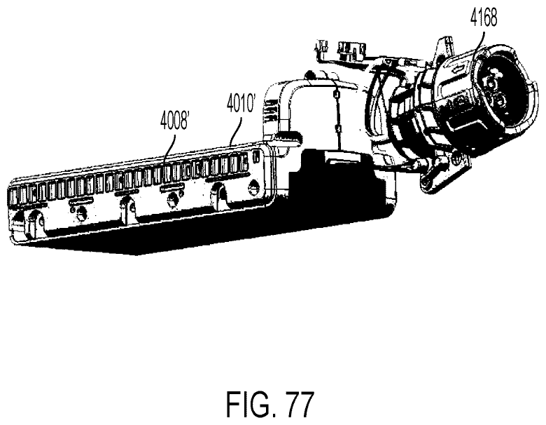

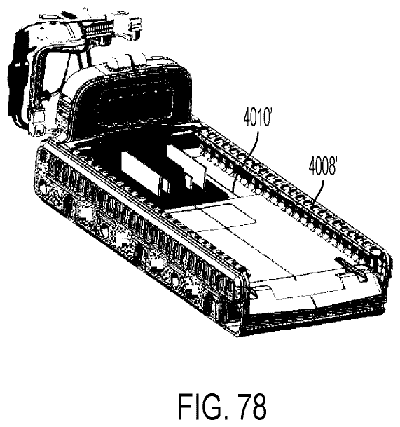

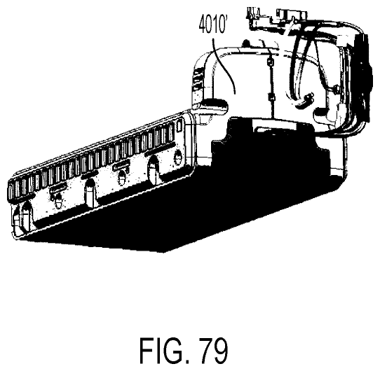

FIGS. 74A-75 show exploded views of the portions of the second cordless power tool 4036′, the interface 4010′, and portions of the façade/outer housing 4126″. FIGS. 76-77 show various views of the interface 4010′ and removably attachable portions 4168 of the second cordless power tool 4036′. FIGS. 78-79 show various views of the interface 4010′. The second cordless power tool 4036′ may be a concrete vibrator backpack 4122, as illustrated in FIGS. 72-77.

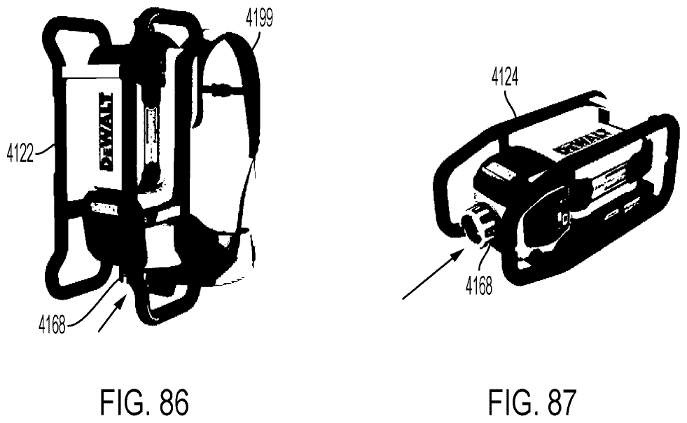

As shown in FIGS. 86-88, the removably attachable portions 4168 of the concrete vibrator backpack 4122 or the concrete vibrator powerpack 4124 may include an electrical connection between the concrete vibrator backpack 4122 or the concrete vibrator powerpack 4124 to the vibrating element/head 4197. The hose 4195 may be configured to couple the power unit to the vibrating head 4197. The length of the hose 4195 may vary. The diameter of the vibrating head 419 may vary.

The second housing 4126″ may include a first housing portion 4170, a second housing portion 4172, a third housing portion 4174, and a bottom housing portion 4148. The first housing portion 4170, the second housing portion 4172, and the third housing portion 4174 may have inter-engaging portions to connect them together and/or they may be connected to each other using aligned holes/openings and fasteners. The first housing portion 4170, the second housing portion 4172, and the third housing portion 4174 together form an internal cavity 4179. The removably attachable portions 4168 of the concrete vibrator backpack 4122 may be received in the internal cavity 4179. When the first housing portion 4170, the second housing portion 4172 and the bottom housing portion 4148 are connected to each other, they are configured to receive and support the interface 4010′ therein/thereon.

The second housing 4126″ may be configured to be coupled with the wire harness 4162 of the user interface 4164 of the concrete vibrator backpack 4122.

The procedures in which the interface 4010′ and the second housing 4126″ may be attached to the concrete vibrator backpack 4122 are explained below. In these procedures, the interface 4010′ and the second housing 4126″ are first connected to each other. The second housing 4126″ (with the interface 4010′) is connected to the concrete vibrator backpack 4122.

The second attachment feature 4128 (and the openings 4130) of the second housing 4126″ may be configured to attach the interface 4010′ to the concrete vibrator backpack 4122 in a second orientation (as shown in FIG. 72). The bottom housing portion 4148 of the second housing 4126″ may be positioned between (a) a combination of the first housing 4008′ and the interface 4010′ and (b) the concrete vibrator backpack 4122. In the second orientation, the interface 4010′ may be positioned in a generally angled orientation with respect to the horizontal axis and the vertical axis. In the second orientation, the interface 4010′ may be in a generally horizontal orientation. In the second orientation, the interface 4010′ may be positioned in a generally vertical orientation in use. In another embodiment, the orientation in use may vary based on application(s) of the tool. In yet another embodiment, the orientation in use may vary based on the use of the tool by user(s). The direction of attachment AD of the interface 4010′ to the concrete vibrator backpack 4122 may be perpendicular to the direction of insertion PID of the battery pack 4006 on to the interface 4010′.

As shown in FIG. 88, the concrete vibrator backpack 4122 may include a harness assembly 4199 that is configured to permit a user to mount the concrete vibrator backpack 4122 to the user's back. The concrete vibrator powerpack 4124 may include a harness assembly 4193. Referring to FIGS. 75 and 88, the second housing portion 4148 may include the harness assembly 4199. Referring to FIG. 75, the third housing portion 4174 may include an electronic control module.

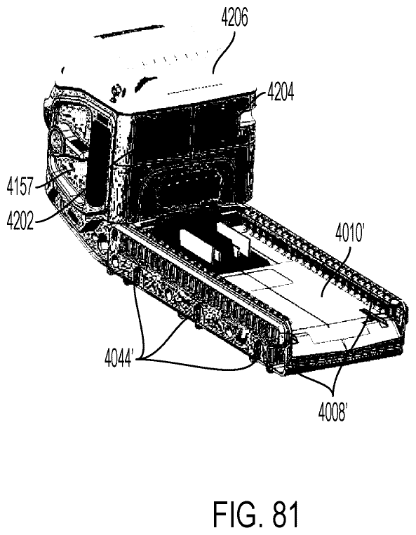

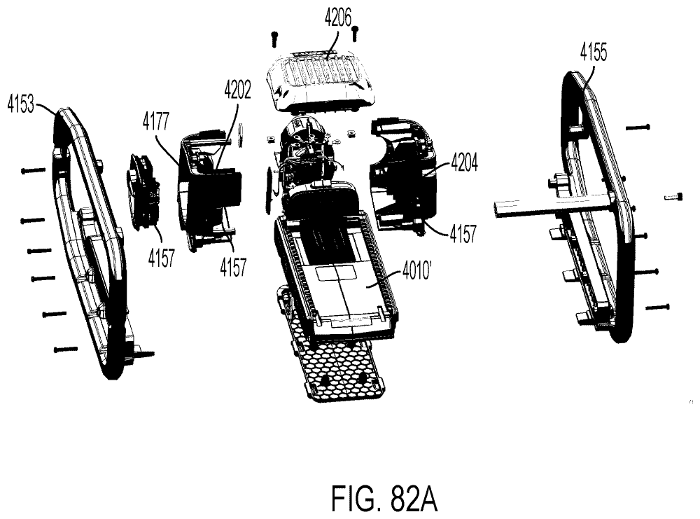

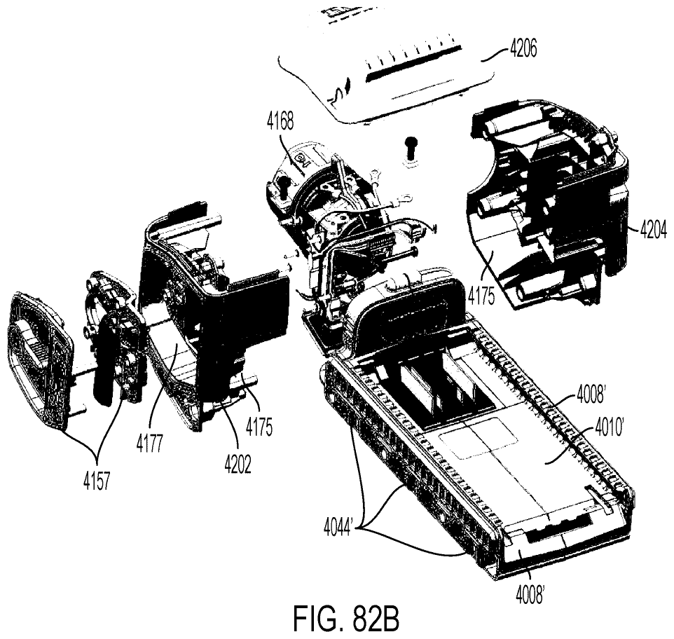

FIG. 80 shows a perspective view of the second cordless power tool 4036′ with the interface 4010′ mounted thereon. FIG. 81 shows show an assembled view of the portions of the second cordless power tool 4036′, the interface 4010′, and portions of the façade/outer housing 4126″. Referring to FIGS. 80 and 82A, the façade/outer housing 4126″ may also include façade/protection cage portions 4153 and 4155. Also, a control unit 4157 is shown in FIG. 82A. FIGS. 82A-85 show exploded views of the portions of the second cordless power tool 4036′, the interface 4010′, and portions of the façade/outer housing 4126″. The second cordless power tool 4036′ may be a vibrator powerpack 4124, as illustrated in FIGS. 80-85.

The second housing 4126″ may include a first housing portion 4202, a second housing portion 4204, a third housing portion 4206, and the bottom housing portion 4148. The first housing portion 4202, the second housing portion 4204, and the third housing portion 4206 may have inter-engaging portions to connect them together and/or they may be connected to each other using aligned holes/openings and fasteners. The first housing portion 4202, the second housing portion 4204, the third housing portion 4206, and portions of the bottom housing portion 4148 together form an internal cavity 4175 (as shown in FIG. 82B). The removably attachable portions 4168 of the concrete vibrator powerpack 4124 may be received in the internal cavity.

The protrusions 4208 on the bottom housing portion 4148 may be configured to engage with the set of holes 4038′ disposed on the core block 4026′ of the interface 4010′ so as to couple the interface 4010′ to the bottom housing portion 4148. The first housing portion 4202 may also include another internal cavity 4177 therein and a cover. The internal cavity 4177 of the first housing portion 4202 may receive some user engageable portions and their corresponding electronic modules therein. Some user engageable portions and their corresponding electronic modules may include the control unit 4157.

The second housing 4126″ may also include side housing members 4210. The side housing members 4210 of the second housing 4126″ may include the second attachment feature 4128 (and the openings 4130) that are configured to attach the interface 4010′ to the concrete vibrator powerpack 4124 in a second orientation (as shown in FIG. 80). There may not be anything on the side of the bottom housing portion opposed to the interface and the bottom housing portion may be simply connected to the first housing. In the second orientation, the interface 4010′ may be positioned in a generally angled orientation with respect to the horizontal axis and the vertical axis. In the second orientation, the interface 4010′ may be in a generally horizontal orientation. In the second orientation, the interface 4010′ may be positioned in a generally vertical orientation in use. The direction of attachment AD of the interface 4010′ to the concrete vibrator powerpack 4124 may be perpendicular to the direction of insertion PID of the battery pack 4006 on to the interface 4010′.

In another embodiment, the holes 4044′ of the first housing 4008′ may also be configured to attach the interface 4010′ to the concrete vibrator powerpack 4124 in the second orientation (as shown in FIG. 80).

The present patent application and its various embodiments as described above uniquely address the observed, noted and researched findings and improve on the prior and current state of the art systems. The listed products, features and embodiments as described in the present patent application should not be considered as limiting in any way.

Although the present patent application has been described in detail for the purpose of illustration, it is to be understood that such detail is solely for that purpose and that the present patent application is not limited to the disclosed embodiments, but, on the contrary, is intended to cover modifications and equivalent arrangements that are within the spirit and scope of the appended claims. In addition, it is to be understood that the present patent application contemplates that, to the extent possible, one or more features of any embodiment can be combined with one or more features of any other embodiment.

The illustration of the embodiments of the present patent application should not be taken as restrictive in any way since a myriad of configurations and methods utilizing the present patent application can be realized from what has been disclosed or revealed in the present patent application. The systems, features and embodiments described in the present patent application should not be considered as limiting in any way. The illustrations are representative of possible construction and mechanical embodiments and methods to obtain the desired features. The location and/or the form of any minor design detail or the material specified in the present patent application can be changed and doing so will not be considered new material since the present patent application covers those executions in the broadest form.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by a person of ordinary skill in the art in the context of the various elements, components, regions, layers and/or sections being described.

The foregoing illustrated embodiments have been provided to illustrate the structural and functional principles of the present patent application and are not intended to be limiting. To the contrary, the present patent application is intended to encompass all modifications, alterations and substitutions within the spirit and scope of the appended claims.

What is claimed is:

1. An interface system for enabling mating and operation between a set of cordless power tools and a battery pack, comprising:
a housing, the housing including an interface for mating with the battery pack, the interface including a set of rails, a set of grooves, a terminal block including a set of terminals, and a catch, the housing including a first attachment feature configured to attach the housing to a first cordless power tool of the set of cordless power tools in a first orientation and a second attachment feature configured to attach the housing to a second cordless power tool of the set of cordless power tools in a second orientation.

2. The interface system, as recited in claim 1, wherein the housing comprises a first housing portion, a second housing portion, and a core block positioned between the first and second housing portions, the core block including the first attachment feature.

3. The interface system, as recited in claim 2, wherein the first attachment feature includes a set of holes in the core block configured to mate with a corresponding fixture on the first cordless power tool.

4. The interface system, as recited in claim 3, wherein the first and second housing portions are attached to the core block such that the set of holes in the core block remain exposed to mate with the corresponding fixture on the first cordless power tool.

5. The interface system, as recited in claim 2, wherein the second attachment feature includes a set of holes in the housing configured to mate with a corresponding fixture on the second cordless power tool.

6. The interface system, as recited in claim 5, wherein the set of holes in the housing is a first set of holes,
wherein the housing includes a second set of holes that are configured to engage with a corresponding set of holes in the core block so as to connect the core block to the housing.

7. The interface system, as recited in claim 1, wherein, in the first orientation, the interface is positioned in a generally vertical orientation.

8. The interface system, as recited in claim 1, wherein, in the second orientation, the interface is positioned in a generally horizontal orientation.

9. The interface system, as recited in claim 1, wherein, in the second orientation, the interface is positioned in a generally angled orientation with respect to a vertical axis and a horizontal axis.

10. The interface system, as recited in claim 2, wherein the terminal block including the set of terminals is disposed on the core block.

11. The interface system, as recited in claim 2, wherein the interface includes a wire harness that is configured to be electrically coupled to either the first cordless power tool or the second cordless power tool.

12. The interface system, as recited in claim 11, wherein the interface includes a tool interface surface that is opposing a battery pack interface surface, and
wherein the wire harness is configured to extend from the tool interface surface.

13. The interface system, as recited in claim 11, wherein the interface includes a front portion and a rear portion,
wherein the catch is disposed in the front portion of the interface, and
wherein the wire harness is configured to extend from a rear surface of the rear portion of the interface.

14. An interface system for enabling mating and operation between a set of cordless power tools and a battery pack, comprising:
a first housing, the first housing including an interface for mating with the battery pack, the interface including a set of rails, a set of grooves, a terminal block including a set of terminals, and a catch, the first housing including a first attachment feature configured to attach the interface to a first cordless power tool of the set of cordless power tools in a first orientation; and
a second housing, the second housing attached to the first housing, the second housing including a second attachment feature configured to attach the interface to a second cordless power tool of the set of cordless power tools in a second orientation, the second housing positioned between the first housing and the second cordless power tool.

15. The interface system, as recited in claim 14, wherein the first housing comprises a first housing portion, a second housing portion, and a core block that is positioned between the first and second housing portions, the core block including the first attachment feature.

16. The interface system, as recited in claim 15, wherein the first attachment feature includes a set of holes in the core block configured to mate with a corresponding fixture on the first cordless power tool.

17. The interface system, as recited in claim 14, wherein the second attachment feature includes a set of holes in the second housing configured to mate with a corresponding fixture on the second cordless power tool.

18. The interface system, as recited in 14, wherein portions of the second housing that are positioned between the first housing and the second cordless power tool are first housing portions of the second housing, and
wherein the second housing includes second housing portions that are positioned on the sides of the first housing and the interface.

19. The interface system, as recited in claim 14, wherein the first housing comprises two housing portions forming an internal cavity and a core block is positioned in the internal cavity.

20. The interface system, as recited in claim 19, wherein the terminal block including the set of terminals is disposed on the core block.

21. The interface system, as recited in claim 19, wherein the interface includes a wire harness that is configured to be electrically coupled to either the first cordless power tool or the second cordless power tool.

22. The interface system, as recited in claim 19, wherein the interface includes a tool interface side that is opposed to a battery pack interface side, and
wherein the wire harness is configured to extend from the tool interface side.

23. The interface system, as recited in claim 19, wherein the interface includes a front portion and a rear portion,
wherein the catch is disposed in the front portion of the interface, and
wherein the wire harness is configured to extend from a rear surface of the rear portion of the interface.

24. The interface system, as recited in claim 14, wherein, in the first orientation, the interface is positioned in a generally vertical orientation.

25. The interface system, as recited in claim 14, wherein, in the second orientation, the interface is positioned in a generally vertical orientation in use.

26. The interface system, as recited in claim 14, wherein, in the second orientation, the interface is positioned in a generally horizontal orientation.

27. The interface system, as recited in claim 14, wherein, in the second orientation, the interface is positioned in a generally angled orientation with respect to a vertical axis and a horizontal axis or in a generally horizontal orientation.

28. The interface system, as recited in claim 14, wherein a direction of attachment of the interface to the first cordless power tool or the second cordless power tool is generally perpendicular to a direction of insertion of the battery pack on to the interface.
